(19) United States
(12) Patent Application Publication
(10) Pub. No.: US 2014/0240336 A1
(43) Pub. Date: Aug. 28, 2014

(54) SIGNAL PROCESSING APPARATUS AND STORAGE MEDIUM

(71) Applicant: SONY CORPORATION, Tokyo (JP)

(72) Inventors: YOICHIRO SAKO, Tokyo (JP); KATSUHISA ARATANI, Kanagawa (JP); KOHEI ASADA, Kanagawa (JP); MITSURU TAKEHARA, Tokyo (JP); YASUNORI KAMADA, Kanagawa (JP); TAKATOSHI NAKAMURA, Tokyo (JP); KAZUNORI HAYASHI, Tokyo (JP); TAKAYASU KON, Tokyo (JP); TOMOYA ONUMA, Shizuoka (JP); AKIRA TANGE, Tokyo (JP); YUKI KOGA, Tokyo (JP); KAZUYUKI SAKODA, Chiba (JP); HIROYUKI HANAYA, Kanagawa (JP)

(73) Assignee: SONY CORPORATION, Tokyo (JP)

(21) Appl. No.: 14/177,617

(22) Filed: Feb. 11, 2014

(30) Foreign Application Priority Data
Feb. 26, 2013 (JP) 2013-035591

(51) Int. Cl. G06T 5/00

(52) U.S. Cl. CPC G06T 5/00
USPC 345/581

(57) ABSTRACT

There is provided a signal processing apparatus including a setting unit configured to set a perceptual property parameter for changing perceptual data to desired perceptual data, and a conversion unit configured to convert currently acquired perceptual data to the desired perceptual data in real time in accordance with the perceptual property parameter that has been set by the setting unit.

### CROSS REFERENCE TO RELATED APPLICATION(S)

This application claims the benefit of Japanese Priority Patent Application JP 2013-035591 filed Feb. 26, 2013, the entire contents of which are incorporated herein by reference.

### BACKGROUND

The present disclosure relates to a signal processing apparatus and a storage medium.

JP 2011-13373A, JP 2008-154192A, and JP 2003-84658A are proposed as apparatuses for allowing users to virtually experience visual states.

Specifically speaking, JP 2011-13373A discloses an apparatus for allowing a user to have visual experience, the apparatus including a filter disposed between an observer and a target and configured to diffuse light, and a calculation unit configured to calculate a distance between the target and the filter in accordance with simulation experience age that has been input.

JP 2008-154192A also discloses an image display system configured to acquire and display image data imaged by an external imaging apparatus such as an imaging apparatus worn by another person and an imaging apparatus mounted on a car, a train, and an animal including a bird.

In addition, JP 2003-84658A discloses an aging experience apparatus including a white light and a yellow light that illuminate a display space, and a light control plate that is installed in front of the display space and is capable of optionally switching between a transparency state and an opacity state. The aging experience apparatus disclosed in JP 2003-84658A can virtually show a visual view seen by older person who have the aged eyes and suffer from a cataract, by showing the display space under the white light or the yellow light through the opaque light control plate.

### SUMMARY

JP 2011-13373A and JP 2003-84658A certainly describe that deterioration of vision influences how a view looks, but do not mention that structural differences of vision change how a view looks.

JP 2008-154192A also discloses the technology for showing visual fields of other people, but does not mention anything about converting, in real time, a current visual field of one person to a view seen by an eye structure other than his/her own eye structure.

The present disclosure therefore proposes a novel and improved signal processing apparatus and storage medium that can convert, in real time, currently sensed perceptual data to perceptual data sensed by a sensory mechanism of another living thing.

According to an embodiment of the present disclosure, there is provided a signal processing apparatus including a setting unit configured to set a perceptual property parameter for changing perceptual data to desired perceptual data, and a conversion unit configured to convert currently acquired perceptual data to the desired perceptual data in real time in accordance with the perceptual property parameter that has been set by the setting unit.

According to another embodiment of the present disclosure, there is provided a non-transitory computer-readable storage medium having a program stored therein, the program causing a computer to function as a setting unit configured to set a perceptual property parameter for changing perceptual data to desired perceptual data, and a conversion unit configured to convert currently acquired perceptual data to the desired perceptual data in real time in accordance with the perceptual property parameter that has been set by the setting unit.

According to one or more of embodiments of the present disclosure, it becomes possible to convert, in real time, currently sensed perceptual data to perceptual data sensed by a sensory mechanism of another living thing.

### BRIEF DESCRIPTION OF THE DRAWINGS

FIG. 1 is a diagram for describing an overview of an HMD according to an embodiment of the present disclosure;

FIG. 2 is a diagram illustrating an internal structure example of an HMD according to a first embodiment;

FIG. 3 is a flowchart illustrating visual conversion processing according to the first embodiment;

FIG. 4 is a diagram illustrating an example of a living-thing selection screen according to the first embodiment;

FIG. 5 is a schematic diagram illustrating conversion examples of a shot image based on visual property parameters according to the first embodiment;

FIG. 6A is a schematic diagram illustrating another conversion example of a shot image based on a visual property parameter according to the first embodiment;

FIG. 6B is a schematic diagram illustrating another conversion example of the shot image based on a visual property parameter according to the first embodiment;

FIG. 6C is a schematic diagram illustrating another conversion example of the shot image based on a visual property parameter according to the first embodiment;

FIG. 7 is a diagram illustrating an example of an input screen according to the first embodiment, in which an era of a desired living thing can be designated;

FIG. 8 is a flowchart illustrating auditory conversion processing according to the first embodiment;

FIG. 9 is a flowchart illustrating other visual conversion processing according to the first embodiment;

FIG. 10 is a schematic diagram illustrating conversion examples of a rainbow image based on visual property parameters;

FIG. 11 is a schematic diagram illustrating conversion examples of a moon image based on visual property parameters;

FIG. 12 is a schematic diagram illustrating conversion examples of a view image based on visual property parameters;

FIG. 13 is a diagram for describing an overview of a second embodiment;

FIG. 14 is a diagram illustrating a functional structure of a main control unit according to the second embodiment;

FIG. 15 is a flowchart illustrating perceptual conversion processing according to the second embodiment;

FIG. 16 is a flowchart illustrating visual conversion processing according to the second embodiment;

FIG. 17 is a flowchart illustrating auditory conversion processing according to the second embodiment; and

FIG. 18 is a flowchart illustrating other perceptual conversion processing according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order:

1. Overview of HMD according to Embodiment of Present Disclosure

### 2. Embodiments

2-1. First Embodiment

2-2. Second Embodiment

### 3. Conclusion

### 1. OVERVIEW OF HMD ACCORDING TO EMBODIMENT OF PRESENT DISCLOSURE

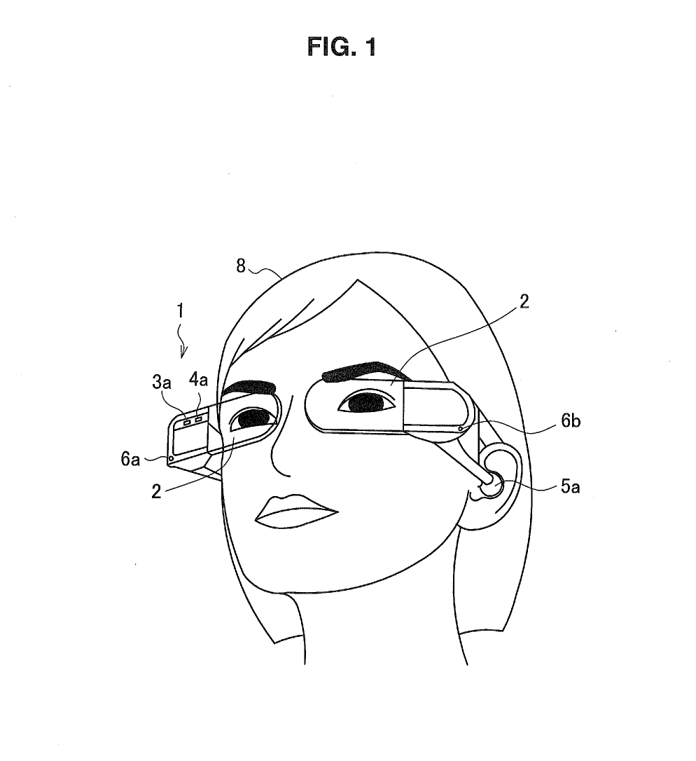

First of all, with reference to FIG. 1, an overview of an HMD 1 (signal processing apparatus) according to an embodiment of the present disclosure will be described.

FIG. 1 is a diagram for describing the overview of the HMD 1 according to an embodiment of the present disclosure. As illustrated in FIG. 1, a user 8 is wearing a glasses-type head mounted display (HMD) 1. The HMD 1 includes a wearable unit that has a frame structured to extend from both the sides of the head to the back of the head, for example. As illustrated in FIG. 1, the user 8 hangs the wearable unit at both the pinnae so that the HMD 1 can be worn by the user 8.

The HMD 1 includes a pair of display units 2 for the left and right eyes, which is disposed in front of both the eyes of the user 8 while the user 8 is wearing the HMD 1. That is, the display units 2 are placed at positions for lenses of usual glasses. For example, the display units 2 display a shot image (still image/moving image) of a real space, which is imaged by an imaging lens 3a. The display units 2 may be transmissive. When the HMD 1 has the display units 2 in a through-state, which namely means that the display units 2 is transparent or translucent, the HMD 1 does not intervene with a daily life of the user 8 if the user 8 constantly wears the HMD 1 like glasses.

As illustrated in FIG. 1, the HMD 1 has the imaging lens 3a facing forward such that an area in a direction which the user visually recognizes is imaged as a subject direction while the user 8 is wearing the HMD 1. A light emitting unit 4a is further installed thereon that illuminates an area in an imaging direction of the imaging lens 3a. The light emitting unit 4a is made of, for example, a light emitting diode (LED).

A pair of earphone speakers 5a, which can be inserted into the right and left ear holes of a user while being worn, is also installed though FIG. 1 illustrates one of the earphone speakers 5a for the left ear alone. Microphones 6a and 6b that collect external sounds are also disposed at the right of the display units 2 for the right eye and the left of the display units 2 for the left eye, respectively.

The exterior appearance of the HMD 1 illustrated in FIG. 1 is just an example. Various structures are conceivable that are used for a user to put on the HMD 1. Generally speaking, the HMD 1 may be just made of a glasses-type wearable unit or a head-mounted wearable unit. At least in the present embodiment, the HMD 1 may just have the display units 2 disposed near and in front of the eyes of a user. The pair of display units 2 is installed for both eyes, but one of the display units 2 alone may also be installed for one of the eyes.

In the illustrated example of FIG. 1, the imaging lens 3a and the illumination unit 4a, which performs illumination, are disposed on the side of the right eye so as to face forward. However, the imaging lens 3a and the illumination unit 4a may also be disposed on the side of the left eye or on both the sides.

Though the earphone speakers 5a have been installed as stereo speakers for the right and left ears, one of the earphone speakers 5a alone may also be installed and put on for the ear. Similarly, one of the microphones 6a and 6b alone may also be sufficient.

It is also conceivable that the microphones 6a and 6b or the earphone speakers 5a are not installed. The light emitting unit 4a does not also have to be necessarily installed.

As above, the exterior structure of the HMD 1 (signal processing apparatus) according to the present embodiment has been described. The HMD 1 has been herein used as an example of a signal processing apparatus that converts perceptual data such as image data and audio data. However, the signal processing apparatus according to an embodiment of the present disclosure is not limited to the HMD 1. For example, the signal processing apparatus may also be a smartphone, a mobile phone terminal, a personal digital assistant (PDA), a personal computer (PC), and a tablet terminal.

Human beings and other animals, insects, and the like have different structures of eyes and visual mechanisms so that a view looks different to them. For example, human beings have no receptor molecules that sense wavelengths in the ultraviolet and infrared ranges, and are therefore unable to see any ultraviolet and infrared rays. To the contrary, it has been known that rodents such as mice and rats, and bats can sense ultraviolet rays. The receptor molecules (visual substances) reside in visual cells, which control vision. Visual substances include a protein termed opsin. A large number of mammals have only two types of opsin genes for color vision so that, for example, dogs and cats have dichromatic vision. Meanwhile, most of the primates including human beings have three types of opsin genes for color vision so that they have trichromatic vision. Some of fish, birds, and reptiles (such as goldfish, pigeons, and frog) have four types of opsin genes for color vision and they have tetrachromatic vision. Thus, it is easy for birds to find objects such as strawberries, which reflect ultraviolet rays well, and to distinguish sex of other birds, which looks identical to the eyes of human beings, because birds have some feathers that reflect ultraviolet rays.

As described above, vision differences of different living things have been described in detail. However, it is not only vision that is different among sensory mechanisms, but auditory mechanisms, olfactory mechanisms, and tactile mechanisms are also different for each living thing. For example, audible ranges for human beings are approximately 15 Hz to 60 kHz, audible ranges for bats are approximately 1.2 kHz to 400 kHz, audible ranges for fish in general are approximately 20 Hz to 3.5 kHz, and audible ranges for parakeets are approximately 200 Hz to 8.5 kHz. Different living things have different audible ranges.

In this way, since other living things have different sensory mechanisms from sensory mechanisms of human beings, other living things are most likely to see different views from human beings are and to hear different sounds from sounds that human beings usually hear.

However, there has not yet been provided any apparatus that provides, in real time, worlds and sounds seen and heard by other living things, respectively. For example, JP 2011-13373A and JP 2003-84658A describe that deterioration of vision influences how a view looks, but do not mention that structural differences of vision change how a view looks. JP 2008-154192A also discloses the technology for showing visual fields of other people, but does not mention anything about what view can be obtained if a current visual field of one person is seen by an eye structure other than his/her eye structure.

Accordingly, in view of such circumstances, the HMD 1 (signal processing apparatus) according to each embodiment of the present disclosure will be proposed. The HMD 1 according to each embodiment of the present disclosure can convert, in real time, currently sensed perceptual data to perceptual data sensed by another living thing with a structurally different sensor mechanism.

The predetermined perceptual property parameters are herein used for conversion of perceptual data such as image data (still image/moving image) and audio data to perceptual data sensed by a desired living thing with a sensory mechanism. The sensory property parameters are accumulated for each living thing in a database in advance.

As above, the overview of the HMD 1 (signal processing apparatus) according to an embodiment of the present disclosure has been described. Next, multiple embodiments will be referenced to describe conversion processing performed by the HMD 1 on perceptual data, in detail.

### 2. EMBODIMENTS

### 2-1. First Embodiment

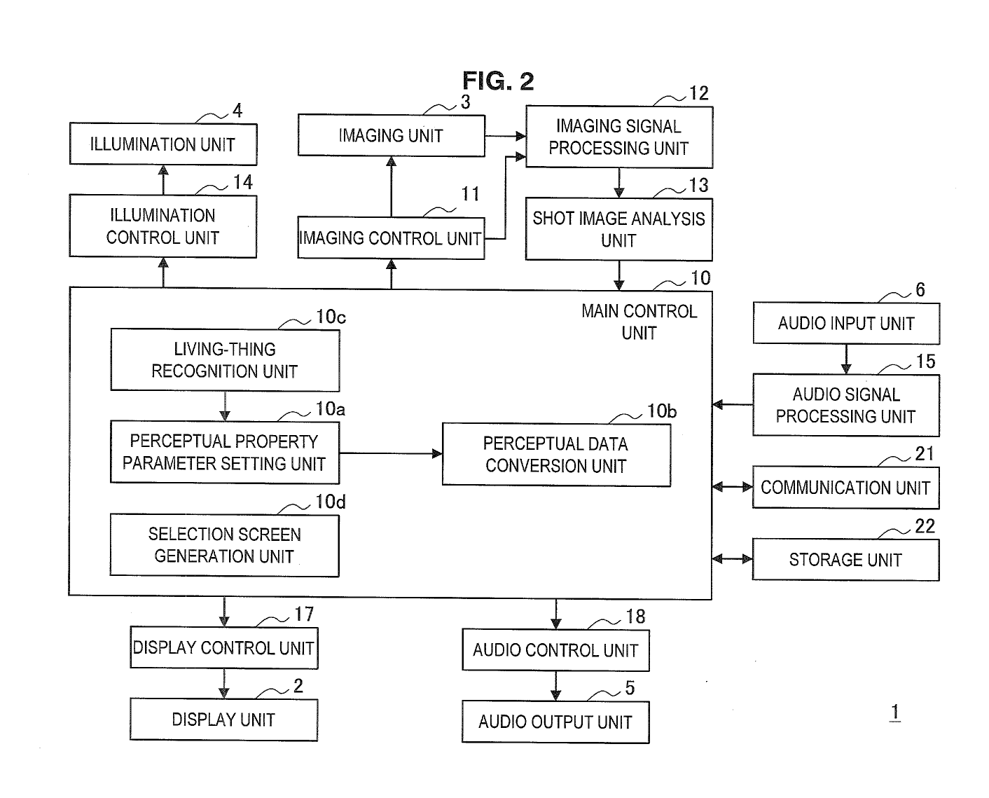

First of all, with reference to FIGS. 2 to 12, the HMD 1 according to a first embodiment will be specifically described.

(2-1-1. Structure)

FIG. 2 is a diagram illustrating an internal structure example of the HMD 1 according to the first embodiment. As illustrated in FIG. 2, the HMD 1 according to the present embodiment includes a display unit 2, an imaging unit 3, an illumination unit 4, an audio output unit 5, an audio input unit 6, a main control unit 10, an imaging control unit 11, an imaging signal processing unit 12, a shot image analysis unit 13, an illumination control unit 14, an audio signal processing unit 15, a display control unit 17, an audio control unit 18, a communication unit 21, and a storage unit 22.

(Main Control Unit 10)

The main control unit 10 includes a microcomputer equipped with a central processing unit (CPU), read only memory (ROM), random access memory (RAM), a non-volatile memory, and an interface unit, and controls each structural element of the HMD 1, for example.

As illustrated in FIG. 2, the main control unit 10 also functions as a perceptual property parameter setting unit 10a, perceptual data conversion unit 10b, a living-thing recognition unit 10c, and a selection screen generation unit 10d.

The perceptual property parameter setting unit 10a sets a perceptual property parameter for conversion of perceptual data to desired perceptual data. The perceptual data is also herein, for example, image data (still image data/moving image data), audio data (audio signal data), pressure data, temperature data, humidity data, taste data, or smell data, and is acquired by various acquisition units such as the imaging unit 3, the audio input unit 6, a pressure sensor, a temperature sensor, a humidity sensor, a taste sensor, and a smell sensor (each of which is not shown). The perceptual property parameter is also a parameter for conversion of perceptual data, the parameter being different in accordance with types of living things. The perceptual property parameter is stored and accumulated as a database in the storage unit 22 or stored on a cloud (external space), and acquired via the communication unit 21. Specifically, the perceptual property parameter includes a visual property parameter, an auditory property parameter, a tactile property parameter, a gustatory parameter, and an olfactory parameter.

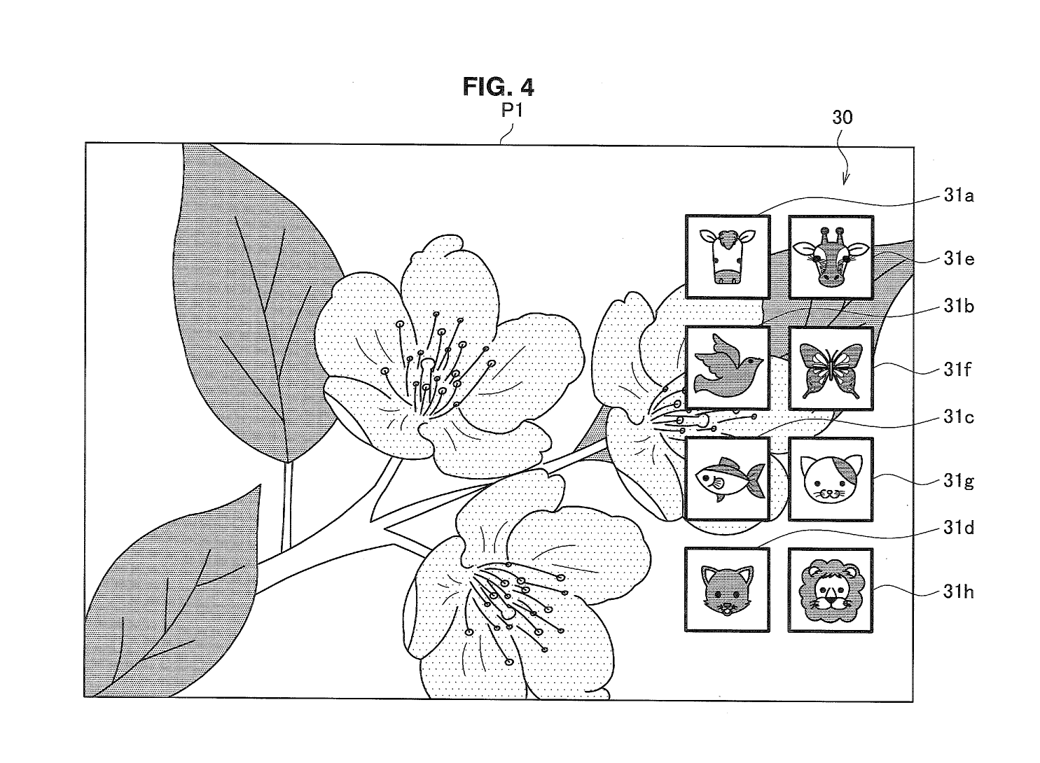

The desired perceptual data is perceptual data sensed by a living thing that is selected by the user 8 (wearer of the HMD 1) in accordance with a living-thing selection screen (see FIG. 4), or a living thing that is present in the surrounding area and recognized by the living-thing recognition unit 10c. The perceptual property parameter setting unit 10a acquires, from the storage unit 22 or a cloud via the communication unit 21, a perceptual property parameter for conversion to such desired perceptual data. Depending on which of a general perceptual conversion mode, a visual conversion mode, an auditory conversion mode, and the like is set, it may be decided which perceptual property parameter is acquired.

For example, when “birds” are selected in the visual conversion mode, the perceptual property parameter setting unit 10a acquires and sets a bird visual property parameter. For example, since the eyes of birds are structured to see ultraviolet rays (tetrachromatic vision), the bird visual property parameter may also be a parameter for visualization of ultraviolet rays.

When “dogs” are selected in the auditory conversion mode, the perceptual property parameter setting unit 10a acquires and sets a dog auditory property parameter. For example, since the audible ranges for dogs are approximately 15 Hz to 60 kHz and dogs are structured to hear ultrasound, which human beings are unable to hear, the dog auditory property parameter may also be a parameter for auralization of ultrasound up to approximately 60 kHz.

The perceptual data conversion unit 10b converts, in real time, perceptual data currently acquired by each acquisition unit to desired perceptual data in accordance with a perceptual property parameter that is set by the perceptual property parameter setting unit 10a, and outputs the converted perceptual data to reproduction units. Each acquisition unit means, for example, the imaging unit 3 and the audio input unit 6. The respective reproduction units are, for example, the display unit 2 and the audio output unit 5.

For example, the perceptual data conversion unit 10b converts, in real time, a shot image imaged by the imaging unit 3 to a view seen by a visual mechanism of a bird in accordance with a bird visual property parameter that is set by the perceptual property parameter setting unit 10a, and outputs the converted view to the display control unit 17. A shot image to be imaged by the imaging unit 3 may include a normal (visible light) shot image and an ultraviolet shot image. Based upon such shot images, the perceptual data conversion unit 10b converts, in real time, the shot image to a view seen by a visual mechanism of a bird in accordance with the set bird visual property parameter. Conversion of perceptual data by the perceptual data conversion unit 10b is herein a concept including replacement of perceptual data. That is, for example, conversion of perceptual data includes switching a shot image to one of images that are imaged by multiple imaging units (such as infrared/ultraviolet cameras, panorama cameras, and fish-eye cameras) having different characters or multiple imaging units having different imaging ranges (angles of view) and imaging directions. The perceptual data conversion unit 10b can convert perceptual data by replacement with a shot image imaged by a predetermined imaging unit in accordance with a set visual property parameter.

The living-thing recognition unit 10c automatically recognizes a living thing present in the surrounding area. Specifically, the living-thing recognition unit 10c can recognize a living thing present in the surrounding area on the basis of an analysis result of the shot image analysis unit 13 on a shot image obtained by the imaging unit 3 imaging the surrounding area.

The selection screen generation unit 10d generates a selection screen for selection of desired perceptual data, and outputs the generated selection screen to the display control unit 17. Specifically, the selection screen generation unit 10d generates a selection screen that includes icons representing animals and insects, which will be described below with reference to FIG. 4. A user can hereby select a desired animal or insect through an eye-gaze input, a gesture input, an audio input, or the like.

(Imaging Unit)

The imaging unit 3 includes, for example, a lens system that includes an imaging lens 3a, a diaphragm, a zoom lens and a focus lens, a driving system that causes the lens system to perform a focus operation and a zoom operation, and a solid-state image sensor array that performs photoelectric conversion on imaging light acquired by the lens system and generates an imaging signal. The solid-state image sensor array may be realized, for example, by a charge coupled device (CCD) sensor array or a complementary metal oxide semiconductor (CMOS) sensor array.

The imaging unit 3 according to the present embodiment can perform special imaging such as ultraviolet imaging and infrared imaging in addition to normal (visible light) imaging.

The HMD 1 according to the present embodiment may also include an imaging lens capable of imaging the eyes of a wearer while the wearer is wearing the HMD 1, thereby allowing the user (wearer) to make an eye-gaze input.

(Imaging Control Unit)

The imaging control unit 11 controls operations of the imaging unit 3 and the imaging signal processing unit 12 on the basis of an instruction from the main control unit 10. For example, the imaging control unit 11 controls switching on/off of the operations of the imaging unit 3 and the imaging signal processing unit 12. The imaging control unit 11 is also configured to perform control (motor control) for causing the imaging unit 3 to perform operations such as autofocusing, adjusting automatic exposure, adjusting a diaphragm, and zooming. The imaging control unit 11 further includes a timing generator, and controls signal processing operations of a solid-state image sensor, and a sample hold/AGC circuit and a video A/D converter of the imaging signal processing unit 12 on the basis of a timing signal generated by the timing generator. The timing control allows an imaging frame rate to be variably controlled.

Moreover, the imaging control unit 11 controls imaging sensitivity and signal processing of the solid-state image sensor and the imaging signal processing unit 12. For example, the imaging control unit 11 can perform gain control as imaging sensitivity control on a signal that has been read from the solid-state image sensor, and also perform black level setting control, various coefficient control for imaging signal processing in digital data, and correction amount control in shake correction processing.

(Imaging Signal Processing Unit)

The imaging signal processing unit 12 includes the sample hold/automatic gain control (AGC) circuit and the video analog/digital (A/D) converter, which perform gain control and waveform shaping on a signal acquired by the solid-state image sensor of the imaging unit 3. The imaging signal processing unit 12 hereby acquires an imaging signal as digital data. In addition, the imaging signal processing unit 12 performs white balance processing, luminance processing, color signal processing, shake correction processing, or the like on an imaging signal.

(Shot Image Analysis Unit)

The shot image analysis unit 13 analyzes image data (shot image) imaged by the imaging unit 3 and processed by the imaging signal processing unit 12, and acquires information on an image included in the image data. Specifically, for example, the shot image analysis unit 13 performs analysis such as point detection, line/contour detection, and region segmentation on image data, and outputs the analysis result to the living-thing recognition unit 10c and the perceptual data conversion unit 10b of the main control unit 10. Since the HMD 1 according to the present embodiment includes the imaging unit 3 and the shot image analysis unit 13, the HMD 1 can receive, for example, a gesture input from a user.

(Illumination Unit and Illumination Control Unit)

The illumination unit 4 includes the light emitting unit 4a illustrated in FIG. 1, and a light emitting circuit that causes the light emitting unit 4a (such as an LED) to emit light. The illumination control unit 14 causes the illumination unit 4 to emit light, under the control of the main control unit 10. The illumination unit 4 has the light emitting unit 4a attached thereto as illustrated in FIG. 1 so as to illuminate an area in front thereof so that the illumination unit 4 illuminates an area in a visual field direction of a user.

(Audio Input Unit and Audio Signal Processing Unit)

The audio input unit 6 includes the microphones 6a and 6b illustrated in FIG. 1, and a microphone/amplifier unit that amplifies audio signals acquired by the microphones 6a and 6b and an A/D converter, and outputs the audio data to the audio signal processing unit 15. The audio signal processing unit 15 performs processing such as noise reduction and sound source separation on the audio data acquired by the audio input unit 6. The audio signal processing unit 15 supplies the processed audio data to the main control unit 10. Since the HMD 1 according to the present embodiment includes the audio input unit 6 and the audio signal processing unit 15, the HMD 1 can receive, for example, an audio input from a user.

The audio input unit 6 according to the present embodiment can collect a special sound such as ultrasound and pick up vibration through a solid object as a sound in addition to a normal sound (in the audible range for human beings).

(Display Control Unit)

The display control unit 17 performs driving control under the control of the main control unit 10 such that the display unit 2 displays image data converted by the perceptual data conversion unit 10b and image data generated by the selection screen generation unit 10d. The display control unit 17 may include a pixel driving circuit for display on the display unit 2, which is, for example, a liquid crystal display. The display control unit 17 can also control a transmittance of each pixel on the display unit 2, and put the display unit 2 into a through-state (transmission state or semi-transmission state).

(Display Unit)

The display unit 2 displays image data under the control of the display control unit 17. The display unit 2 is realized by a device that has the display control unit 17 control the transmittance and can be in a through-state.

(Audio Control Unit)

The audio control unit 18 performs control under the control of the main control unit 10 such that audio signal data converted by the perceptual data conversion unit 10b is output from the audio output unit 5.

(Audio Output Unit)

The audio output unit 5 includes the pair of earphone speakers 5a illustrated in FIG. 1, and an amplifier circuit for the earphone speakers 5a. The audio output unit 5 may also be configured as a so-called bone conduction speaker.

(Storage Unit)

The storage unit 22 is a unit that records and reproduces data on a predetermined recording medium. The storage unit 22 is realized, for example, as a hard disk drive (HDD). Needless to say, various recording media such as solid-state memories including flash memories, memory cards having solid-state memories built therein, optical discs, magneto-optical disks, and hologram memories are conceivable. The storage unit 22 just has to be configured to record and reproduce data in accordance with a recording medium to be adopted.

The storage unit 22 according to the present embodiment stores a perceptual property parameter of each living thing. For example, the storage unit 22 stores a conversion Eye-Tn as a visual property parameter for conversion of a view seen by the eyes of human beings to a view seen by the eyes of other living things. The storage unit 22 also stores a conversion Ear-Tn as an auditory property parameter for conversion of a sound heard by the ears of human beings to a sound heard by the ears of other living things. Note that n represents herein a natural number and n increases in accordance with how many perceptual property parameters are accumulated for each living thing in a database. The storage unit 22 may automatically replace a perceptual property parameter with the latest perceptual property parameter that is acquired on a network via the communication unit 21.

(Communication Unit)

The communication unit 21 transmits and receives data to and from an external apparatus. The communication unit 21 directly communicates with an external apparatus or wirelessly communicates with an external apparatus via a network access point in a scheme such as a wireless local area network (LAN), wireless fidelity (Wi-Fi, registered trademark), infrared communication, and Bluetooth (registered trademark).

As above, the internal structure of the HMD 1 according to the present embodiment has been described in detail. The internal structure illustrated in FIG. 2 is just an example. The internal structure of the HMD 1 according to the present embodiment is not limited to the example illustrated in FIG. 2. For example, the HMD 1 may also include various reproduction units each of which reproduces pressure data, temperature data, humidity data, taste data, or smell data converted by the perceptual data conversion unit 10b.

The above-described structure allows the HMD 1 according to the present embodiment to convert, in real time, perceptual data acquired by the imaging unit 3 or the audio input unit 6 on the basis of a perceptual property parameter according to a desired living thing, and to provide the converted perceptual data. Next, operational processing of the HMD 1 according to the present embodiment will be described.

(2-1-2. Operational Processing)

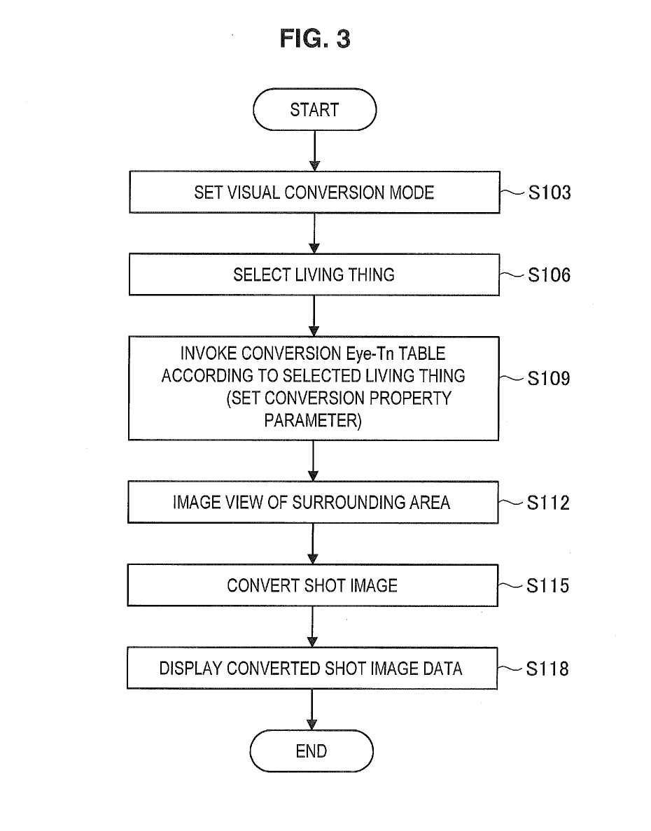

FIG. 3 is a flowchart illustrating visual conversion processing according to the first embodiment. As illustrated in FIG. 3, first of all, the HMD 1 is set to a visual conversion mode by the user 8 in step S103. The HMD 1 may also be set to a visual conversion mode through an operation of a switch (not shown) installed around the display unit 2 of the HMD 1, for example.

Next, in step S106, the main control unit 10 of the HMD 1 issues an instruction to the display control unit 17 such that the display unit 2 displays a living-thing selection screen generated by the selection screen generation unit 10d. FIG. 4 illustrates an example of the living-thing selection screen. As illustrated in FIG. 4, a selection screen 30 that includes icons 31a to 31h representing living things is superimposed on a shot image P1 displayed on the display unit 2 in real time, or displayed on the display unit 2 in a transmission state. The user 8 selects an icon 31 representing a desired living thing through an eye-gaze input, a gesture input, or an audio input.

Subsequently, in step S109, the perceptual property parameter setting unit 10a invokes a conversion Eye-Tn table according to the selected living thing and sets a visual property parameter for visual conversion.

Next, in step S112, the imaging unit 3 images a view of the surrounding area and transmits the shot image to the perceptual data conversion unit 10b via the imaging signal processing unit 12 and the shot image analysis unit 13. The imaging unit 3 may also be continuously imaging views once the visual conversion mode is set in S103.

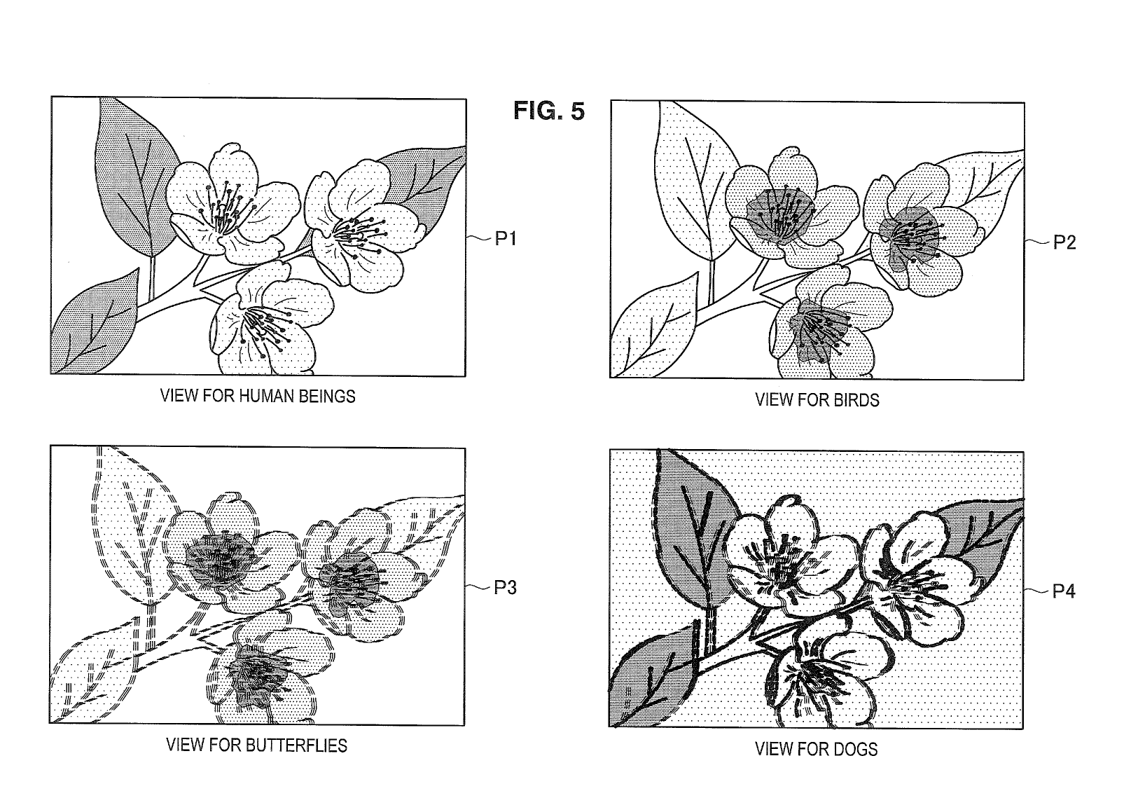

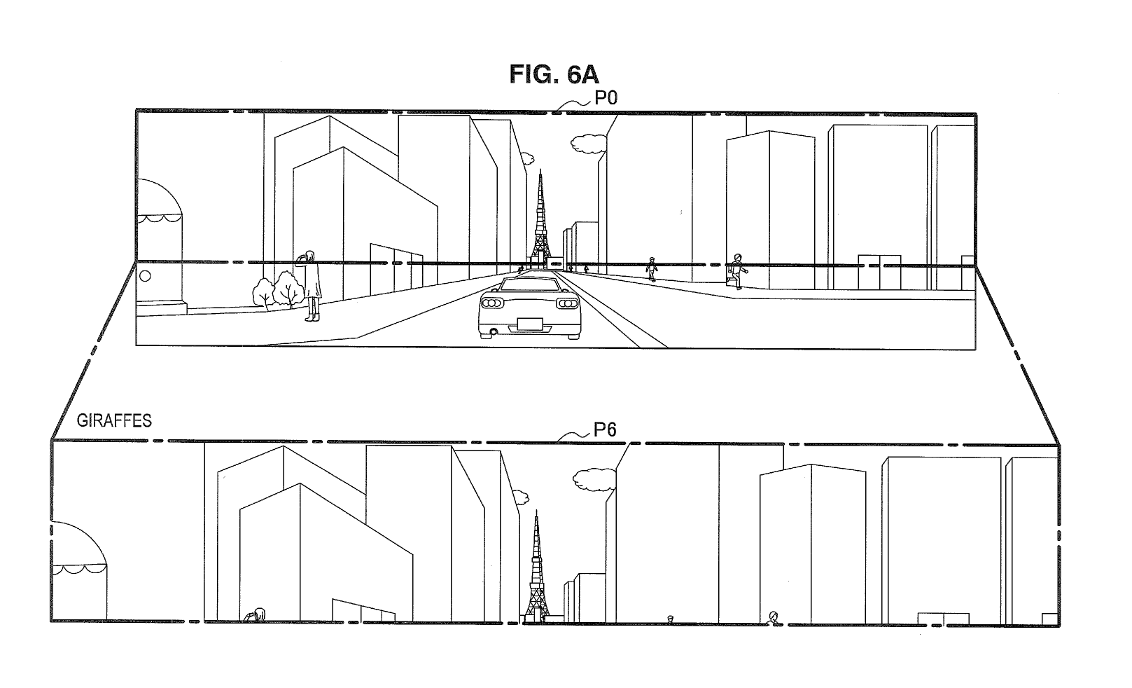

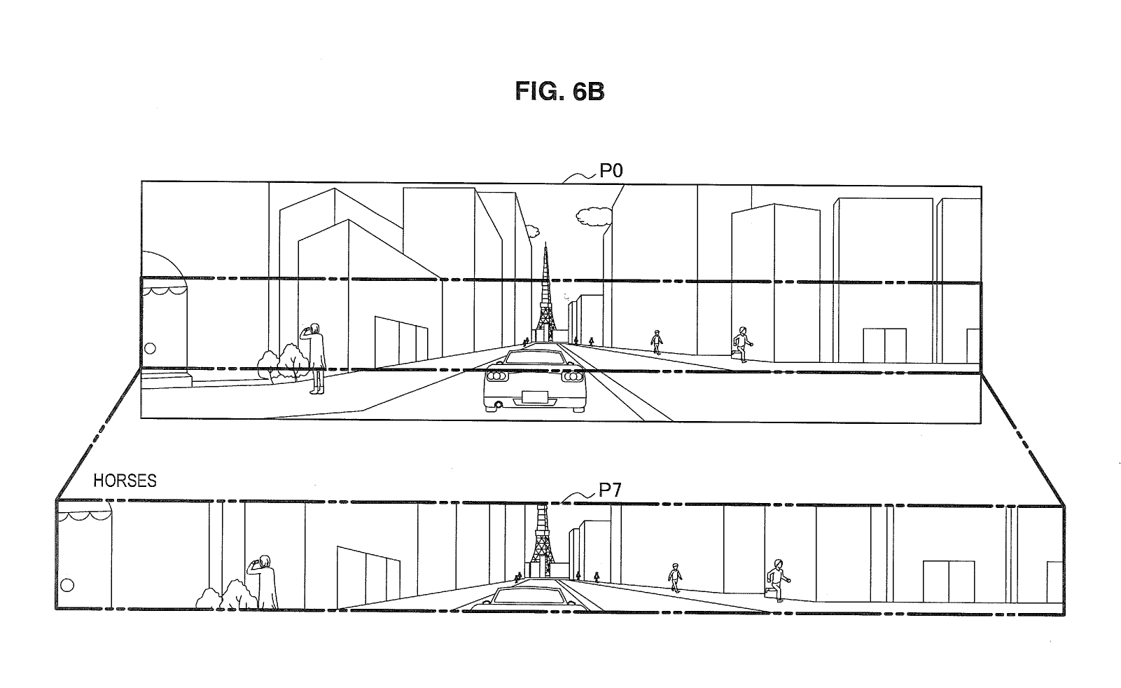

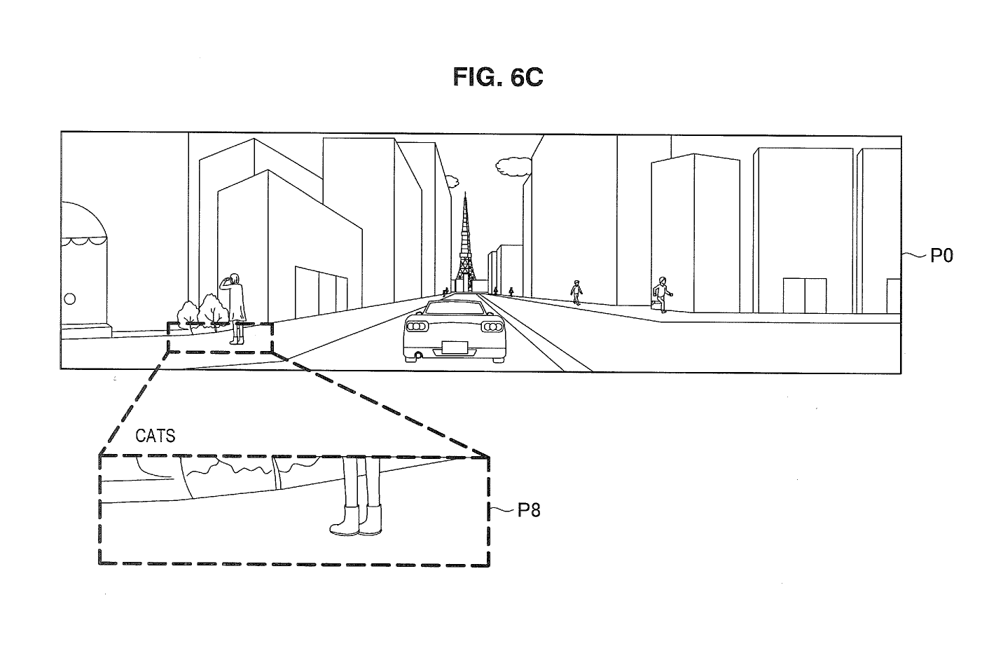

Subsequently, in step S115, the perceptual data conversion unit 10b converts the shot image imaged by the imaging unit 3 on the basis of the visual property parameter that has been set by the perceptual property parameter setting unit 10a. With reference to FIGS. 5 to 6 (FIGS. 6A to 6C), conversion examples of image data will be described.

FIG. 5 is a schematic diagram illustrating conversion examples of a shot image based on visual property parameters. FIG. 5 has a shot image P1 that illustrates a view for the eyes of human beings, a conversion image P2 that has been converted so as to illustrate a view for the eyes of birds, a conversion image P3 that has been converted so as to illustrate a view for the eyes of butterflies, and a conversion image P4 that has been converted so as to illustrate a view for the eyes of dogs.

For example, when the shot image P1 is converted on the basis of a visual property parameter Eye-T1 for conversion to a view for the eyes of birds, the shot image P1 is converted to the conversion image P2 that expresses, in a specific color or a specific pattern, a region in which reflection of ultraviolet rays is detected since the eyes of birds are structured to see even ultraviolet rays (tetrachromatic vision). The user 8 is hereby provided with an image expressing a view seen by the eyes of birds.

Similarly when the shot image P1 is converted on the basis of a visual property parameter Eye-T2 for conversion to a view for the eyes of butterflies, the shot image P1 is converted to the conversion image P3 that expresses an ultraviolet reflection region in a specific color or the like, and approaches and blurs the focal point since the eyes of butterflies are also structured to see even ultraviolet rays (tetrachromatic vision) and to have lower eyesight than the eyesight of human beings. The user 8 is hereby provided with an image expressing a view seen by the eyes of butterflies.

When the shot image P1 is converted on the basis of a visual property parameter Eye-T3 for conversion to a view for the eyes of dogs, the shot image P1 is converted to the conversion image P4 that is expressed in predetermined two primary colors (such as blue and green), and approaches and blurs the focal point since the eyes of dogs are structured to have dichromatic vision and to have lower eyesight than the eyesight of human beings. The user 8 is hereby provided with an image expressing a view seen by the eyes of dogs.

FIGS. 6A to 6C are schematic diagrams illustrating other conversion examples of a shot image based on visual property parameters. The perceptual data conversion unit 10b converts a shot image P0 panoramically imaged by the imaging lens 3a to image data on the basis of the a visual property parameter Eye-Tn of each living thing, the image data obtained by clipping a range according to the viewing angle or the viewpoint of each living thing from the shot image P0.

For example, as illustrated in FIG. 6A, when based on a giraffe visual property parameter Eye-T4, the perceptual data conversion unit 10b converts the panoramically imaged shot image P0 to a conversion image P6 obtained by clipping an upper range (viewpoint of giraffes) from the panoramically imaged shot image P0 at the viewing angle of approximately 350 degrees (viewing angle of giraffes). As illustrated in FIG. 6B, when based on a horse visual property parameter Eye-T5, the perceptual data conversion unit 10b converts the panoramically imaged shot image P0 to a conversion image P7 obtained by clipping a central range (viewpoint of horses) from the panoramically imaged shot image P0 at the viewing angle of approximately 350 degrees (viewing angle of horses). Additionally, horses are each unable to see the tip of the nose within the viewing angle because the tip of the nose is a blind spot for horses. However, the conversion image P7 does not reflect (show) the blind spot. As illustrated in FIG. 6C, when based on a cat visual property parameter Eye-T6, the perceptual data conversion unit 10b converts the panoramically imaged shot image P0 to a conversion image P8 obtained by clipping a lower range (viewpoint of cats) from the panoramically imaged shot image P0 at the viewing angle of approximately 280 degrees (viewing angle of cats).

As above, with reference to FIGS. 5 and 6, the specific conversion examples of image data based on visual property parameters have been described. The conversion examples of image data according to the present embodiment, which are based on visual property parameters, are not limited to the conversion illustrated in FIGS. 5 and 6. A shot image may also be converted to image data based on a visual property parameter obtained by taking it into consideration that carnivores such as cats and dogs have binocular vision and herbivores such as giraffes and horses also have binocular vision. The shot image P0 may be made of multiple shot images imaged by multiple imaging lenses 3a. A predetermined range may be hereby clipped from a shot image obtained by imaging a wider area than the viewing angle of a user (human being) having on the HMD 1, on the basis of the set visual property parameter.

In step S118 of FIG. 3, the main control unit 10 issues an instruction to the display control unit 17 such that the display unit 2 displays the image data (conversion image) converted by the perceptual data conversion unit 10b.

As described above, the HMD 1 according to the present embodiment can convert, in real time, a view seen by the user 8 to a view seen by the eyes of a living thing selected by the user 8, and provide the converted view. The perceptual data conversion unit 10b according to the present embodiment can also convert perceptual data on the basis of a perceptual property parameter according to evolution of each living thing. Since a living thing has sensory mechanisms that have changed in accordance with evolution, the perceptual data conversion unit 10b can also provide a view seen by the selected living thing thirty million years ago or two hundred million years ago, for example, once the perceptual data conversion unit 10b acquires what have been accumulated in a database as visual property parameters.

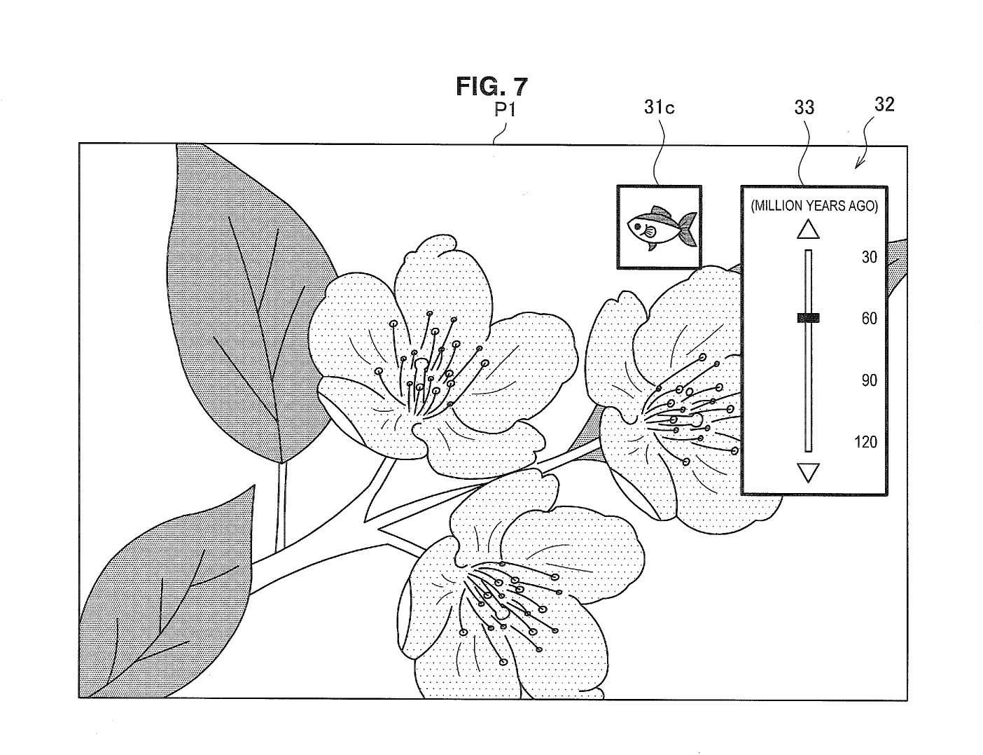

FIG. 7 illustrates an example of an input screen 32 in which an era of a desired living thing can be designated. As illustrated in FIG. 7, the input screen 32 is displayed, for example, when an icon 31c representing a fish is selected. The input screen 32 includes the selected fish icon 31c and era bar display 33 for designation of the fish era. The user 8 can designate a desired era through an eye-gaze input, a gesture input, or an audio input.

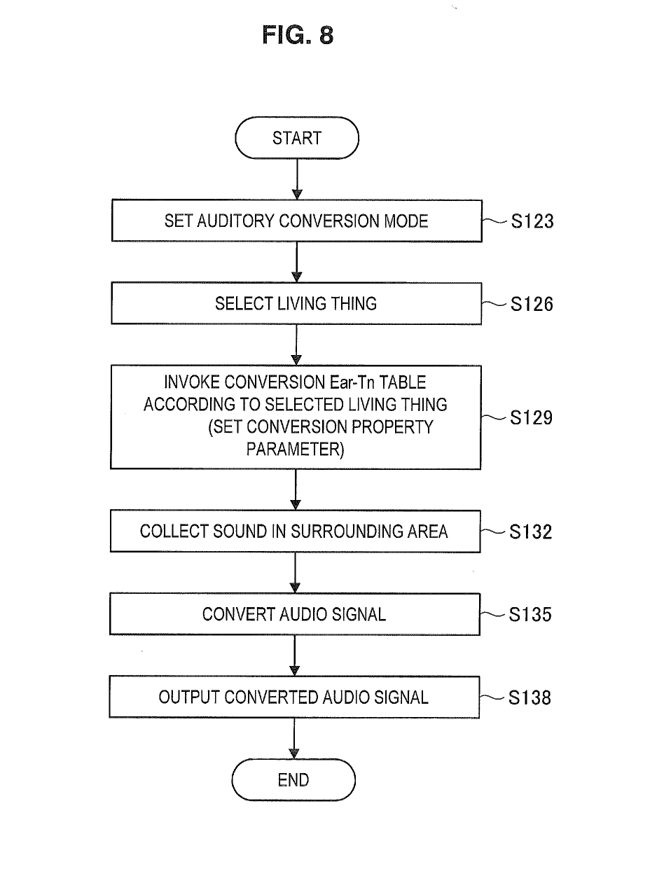

As above, with reference to FIGS. 3 to 7, the visual conversion processing according to the present embodiment has been specifically described. The HMD 1 according to the present embodiment is not limited to the visual conversion processing illustrated in FIG. 7. The HMD 1 according to the present embodiment can also convert perceptual data sensed by various sensory organs like auditory conversion processing and olfactory conversion processing. As an example, with reference to FIG. 8, auditory conversion processing according to the present embodiment will be described.

FIG. 8 is a flowchart illustrating auditory conversion processing according to the first embodiment. As illustrated in FIG. 8, first of all, the HMD 1 is set, in step S123, to an audio conversion mode by the user 8. The HMD 1 may also be set to an auditory conversion mode, for example, through an operation of a switch (not shown) installed around the earphone speakers 5a of the HMD 1.

Next, in step S126, the main control unit 10 of the HMD 1 issues an instruction to the display control unit 17 such that the display unit 2 displays a living-thing selection screen (see FIG. 4) generated by the selection screen generation unit 10d. The user 8 selects an icon 31 representing a desired living thing through an eye-gaze input, a gesture input, or an audio input. The HMD 1 may also facilitate the user 8 with an audio output from the earphone speakers 5a to select a desired living thing.

Subsequently, in step S129, the perceptual property parameter setting unit 10a invokes a conversion Ear-Tn table according to the selected living thing, and sets an auditory property parameter for auditory conversion.

Next, in step S132, the audio input unit 6 collects a sound in the surrounding area. The collected audio signal is transmitted to the perceptual data conversion unit 10b via the audio signal processing unit 15. The audio input unit 6 may continuously collect sounds since the auditory conversion mode is set in S123.

Subsequently, in step S135, the perceptual data conversion unit 10b converts the audio signal collected by the audio input unit 6, on the basis of the auditory property parameter that has been set by the perceptual property parameter setting unit 10a. For example, the perceptual data conversion unit 10b converts ultrasound collected by the audio input unit 6 to an audible sound on the basis of the set auditory property parameter.

In step S138, the main control unit 10 issues an instruction to the audio control unit 18 such that the audio signal (converted audio data) converted by the perceptual data conversion unit 10b is reproduced from the audio output unit 5.

The HMD 1 can hereby convert a sound heard by the user 8 to a sound heard by the ears of a desired living thing in real time, and reproduce the converted sound.

As above, auditory conversion processing performed by the HMD 1 has been described.

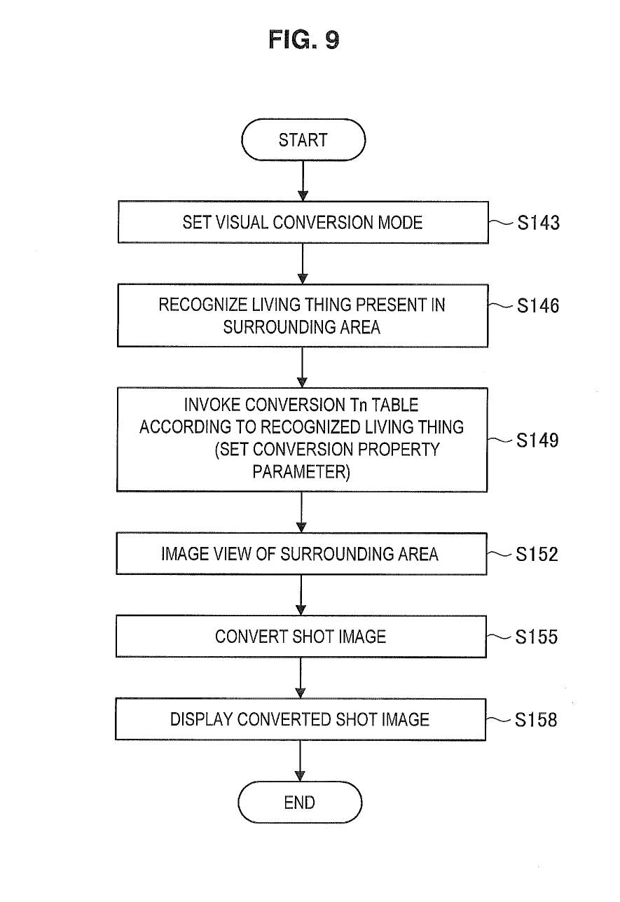

Furthermore, the HMD 1 according to the present embodiment is not limited to a living thing that is selected by a user from the selection screen 30 as illustrated in FIG. 4. The HMD 1 according to the present embodiment may also automatically recognize a living thing present in the surrounding area, and set a perceptual property parameter according to the recognized living thing. The HMD 1 can hereby automatically set a perceptual property parameter of a living thing that inhabits in the area surrounding the user 8. Next, with reference to FIG. 9, operational processing of automatically recognizing a living thing present in the surrounding area will be described below.

FIG. 9 is a flowchart illustrating other visual conversion processing according to the first embodiment. As illustrated in FIG. 9, first of all, the HMD 1 is set to a visual conversion mode by the user 8 in step S143. The HMD 1 may also be set to a visual conversion mode, for example, through an operation of a switch (not shown) installed around the display unit 2 of the HMD 1.

Next, in step S146, the living-thing recognition unit 10c of the HMD 1 recognizes a living thing present in the area surrounding the user 8. A living thing may also be recognized on the basis of an analysis result of a shot image obtained by the imaging unit 3 imaging the surrounding area. The recognized living thing here includes an animal other than a human being, an insect, and a human being other than the user 8. When a human being is recognized, the living-thing recognition unit 10c identifies a type (race) or sex of the human being, for example. For example, human beings belonging to different races may have different colors of the eyes, differently feel light, or differently see a view. Racial differences may bring about environmental and cultural differences and cause human beings to differently classify colors so that human beings come to differently see a view. Furthermore, sex may also influence how a view looks. For example, fruit such as oranges may look a little redder to the eyes of men than the eyes of women. Similarly, green plants may look greener to the eyes of women almost unconditionally, while they may look a little yellowish to the eyes of men. In this way, racial and sexual differences may change how the world looks. Accordingly, the living-thing recognition unit 10c also recognizes another human being as a living thing present in the surrounding area, and outputs the recognition result to the perceptual property parameter setting unit 10a.

Subsequently, in step S149, the perceptual property parameter setting unit 10a invokes a conversion Tn table according to the living thing recognized by the living-thing recognition unit 10c from the storage unit 22 or a cloud via the communication unit 21, and sets a visual property parameter for visual conversion.

Next, in step S152, the imaging unit 3 images a view of the surrounding area. The shot image is transmitted to the perceptual data conversion unit 10b via the imaging signal processing unit 12 and the shot image analysis unit 13. The imaging unit 3 may also continuously image views once the visual conversion mode is set in S103.

Subsequently, in step S155, the perceptual data conversion unit 10b converts the shot image imaged by the imaging unit 3 on the basis of the visual property parameter that has been set by the perceptual property parameter setting unit 10a.

In step S158, the main control unit 10 issues an instruction to the display control unit 17 such that the display unit 2 displays the image data (conversion image) converted by the perceptual data conversion unit 10b.

In this way, the HMD 1 can set a visual property parameter according to a living thing present in the surrounding area, convert, in real time, a view seen by the user 8 to a view seen by the eyes of the living thing present in the surrounding area, and provide the converted view. The HMD 1 can also recognize another human being as a living thing present in the surrounding area, and provide view differences due to racial and sexual differences. Accordingly, when used between a married couple or a couple, or at a homestay destination, the HMD 1 allows the user to grasp how a view looks to people who are near the user and belong to the different sex or different races. The user can hereby find a surprising view that is differently seen by people near the user.

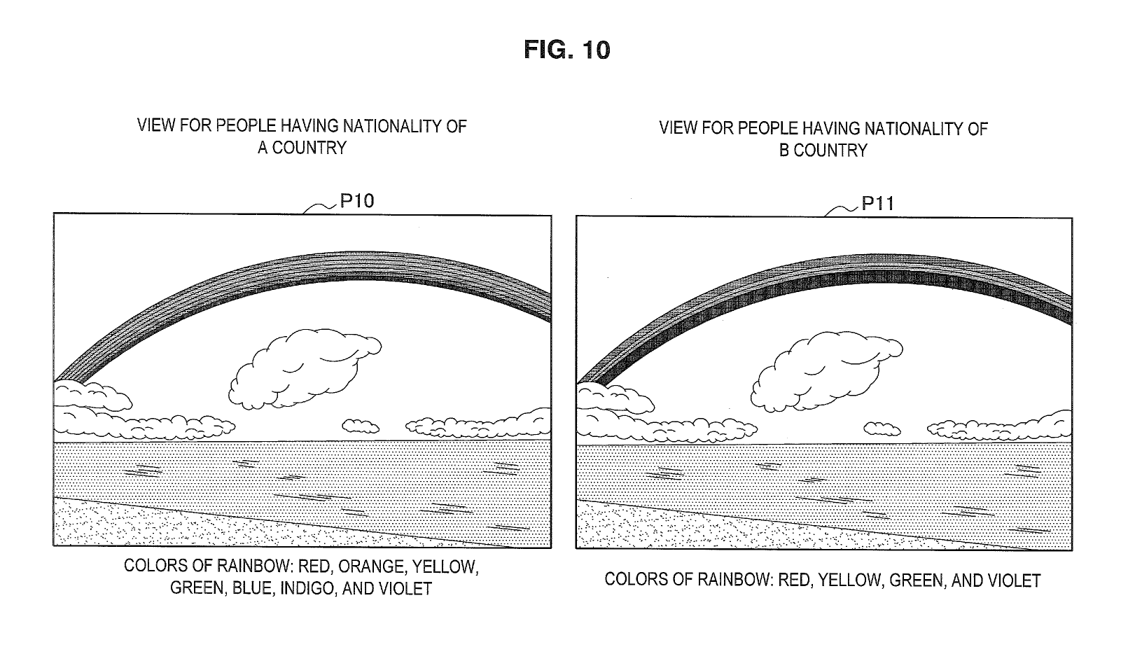

The HMD 1 may also provide a view difference due to an age difference in addition to view differences due to racial and sexual differences. In this case, it becomes possible to grasp how a view looks to people at different ages such as children and parents, grandchildren and grandparents, and adults and kids (including teachers and students). As an example, with reference to FIGS. 10 to 12, a conversion example of image data that takes a view difference due to a racial difference into consideration will be described.

FIG. 10 is a schematic diagram illustrating conversion examples of a rainbow image based on visual property parameters. It has been known that some countries, ethnic groups, and cultures have six colors or seven colors for a rainbow, and others have four colors. That is because different cultures may differently classify colors and have different common knowledge though human beings have the same eye structure.

Accordingly, the HMD 1 according to the present embodiment provides a conversion image P10 that, for example, emphasizes a rainbow in seven colors for people having the nationality of A country on the basis of a visual property parameter according to the race (such as the country, the ethnic group, and the culture) of the recognized (identified) person, while the HMD 1 provides a conversion image P11 that emphasizes a rainbow in four colors for people having the nationality of B country. The user 8 can hereby grasp how a view looks to people belonging to different races and having different cultures.

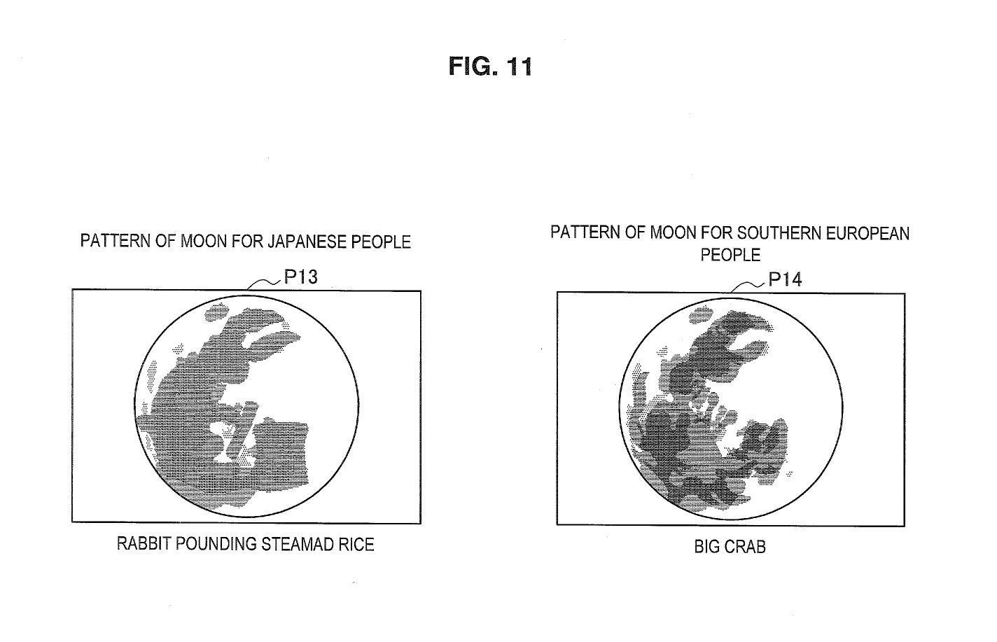

FIG. 11 is a schematic diagram illustrating conversion examples of a moon image based on visual property parameters. It has been known that the pattern of the moon looks like “a rabbit pounding steamed rice,” “a big crab,” or “a roaring lion” to some countries, ethnic groups, and cultures. The moon has the same surface exposed to the earth all the time so that the same pattern of the moon can be seen from the earth. However, the pattern of the moon looks different in accordance with the nature, the customs, and the traditions of locations from which the moon is observed. For example, the pattern of the moon looks like a rabbit pounding steamed rice to a large number of Japanese people. Meanwhile, people in islands in the Pacific Ocean, where there are no rabbits inhabiting, do not associate the pattern of the moon with a rabbit, while they are likely to associate the pattern with an animal (such as a lion and a crocodile) inhabiting in the region. They may also associate the pattern of the moon with a man or a woman (such as a man and a woman carrying a bucket) in a legend or a myth that has come down in the region.

Accordingly, the HMD 1 according to the present embodiment provides a conversion image P13 that, for example, emphasizes the pattern of the moon in the form of a rabbit for Japanese people on the basis of a visual property parameter according to the race (such as the country, the ethnic group, and the culture) of the recognized (identified) human being, while the HMD 1 provides a conversion image P14 that emphasizes the pattern of the moon in the form of a crab for Southern European people. The user 8 can hereby grasp how the pattern of the moon looks to people belonging to different races and having different cultures.

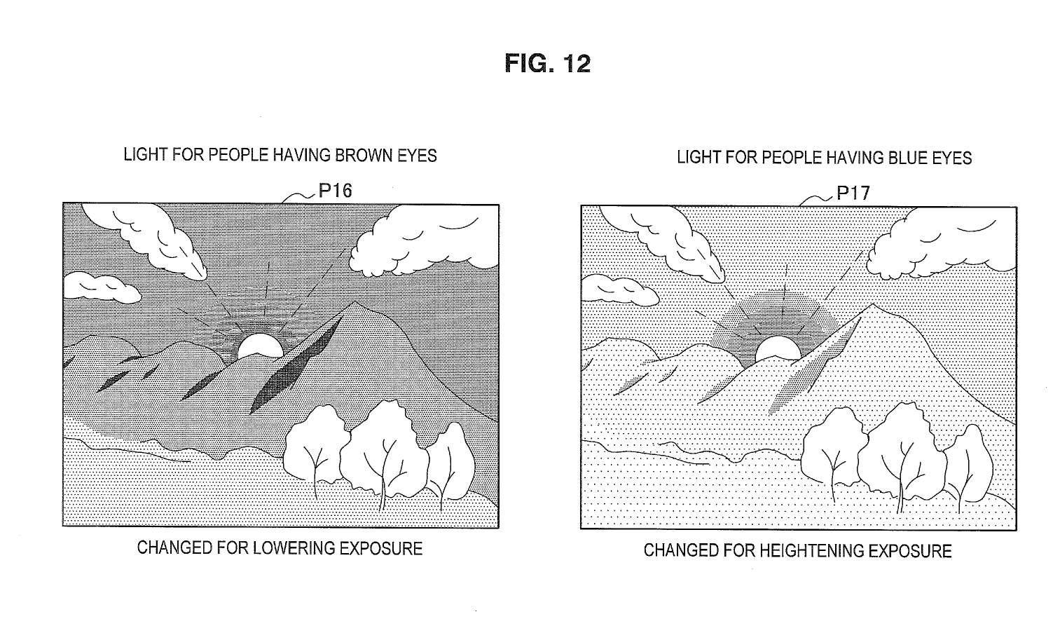

FIG. 12 is a schematic diagram illustrating conversion examples of a view image based on visual property parameters. For example, it has been known that different colors of eyes (colors of irises) make people differently feel light though human beings have the same eye structure. Colors of eyes are a hereditary physical feature, and decided chiefly by a proportion of melanin pigments produced by melanocytes in irises. Since blue eyes have less melanin pigments, blue eyes are, for example, more apt to feel light strongly (feel light is more dazzling) than brown eyes.

Accordingly, the HMD 1 according to the present embodiment provides a conversion image P16 in which a level of exposure is lowered, for example, for people having the brown eyes on the basis of a visual property parameter according to a color of eyes estimated from the race of the recognized (identified) human being or the identified color of the eyes, while the HMD 1 provides a conversion image P17 in which a level of exposure is heightened for people having the blue eyes. The user 8 can hereby grasp how light is felt by people belonging to different races (having different colors of the eyes).

As above, the conversion examples of image data taking it into consideration that a racial difference influences how a view looks have been described. The conversion processing according to the present embodiment is not limited to the visual conversion processing described with reference to FIGS. 9 to 12. Conversion processing on perceptual data sensed by various sensory organs such as auditory conversion processing and olfactory conversion processing is also conceivable.

The HMD 1 according to the present embodiment may also be used by doctors for diagnosis. The HMD 1 worn by a doctor automatically recognizes a patient present in the surround area, acquires a perceptual property parameter of the patient from a medical information server on a network via the communication unit 21, and sets the perceptual property parameter. The medical information server stores perceptual property parameters based on diagnostic information or symptomatic information of patients, in advance. The HMD 1 converts, in real time, a shot image imaged by the imaging unit 3 or audio signal data collected by the audio input unit 6 in accordance with the set perceptual property parameter, and reproduces the converted shot image or the converted audio signal from the display unit 2 or the audio output unit 5, respectively.

Doctors can hereby grasp what view patients see and what sound the patients hear, through conversion of perceptual data based on perceptual property parameters of the patients, even when the patients are unable to verbally and correctly express their symptoms.

### 2-2. Second Embodiment

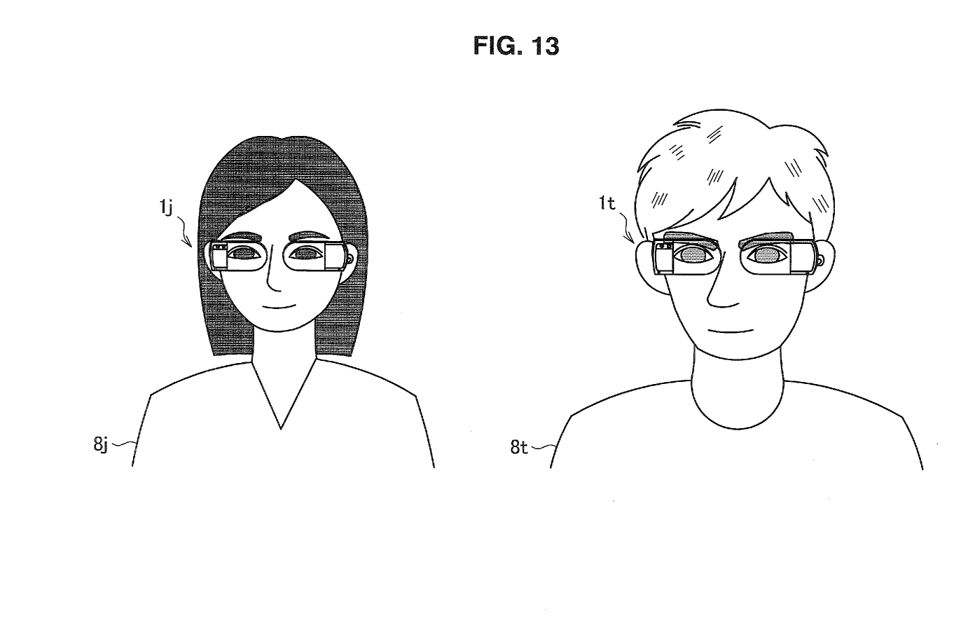

As above, the HMD 1 according to the first embodiment has been described. It has been described in the first embodiment that the single HMD 1 alone performs perceptual conversion processing. However, when there are multiple HMDs 1, the HMDs 1 can also transmit and receive perceptual data and perceptual property parameters to and from each other. Next, with reference to FIGS. 13 to 18, perceptual conversion processing performed by multiple HMDs 1 will be described as a second embodiment.

(2-2-1. Overview)

FIG. 13 is a diagram for describing an overview of the second embodiment. As illustrated in FIG. 13, a user 8j wears an HMD 1j, while a user 8t wears an HMD 1t. The HMD 1j can transmit a perceptual property parameter of the user 8j to the HMD 1t, and also transmit perceptual data acquired by the HMD 1j to the HMD 1t.

The user 8j can hereby show the user 8t how the user 8j sees a view and hears a sound. When, for example, the multiple HMDs 1j and 1t are used between a married couple or a couple, at a homestay destination, or between parents and children or adults and kids (such as teachers and students), it is possible to show people belonging to the different sex, races, and different age present in the surrounding area how a view looks and a sound sounds.

(2-2-2. Structure)

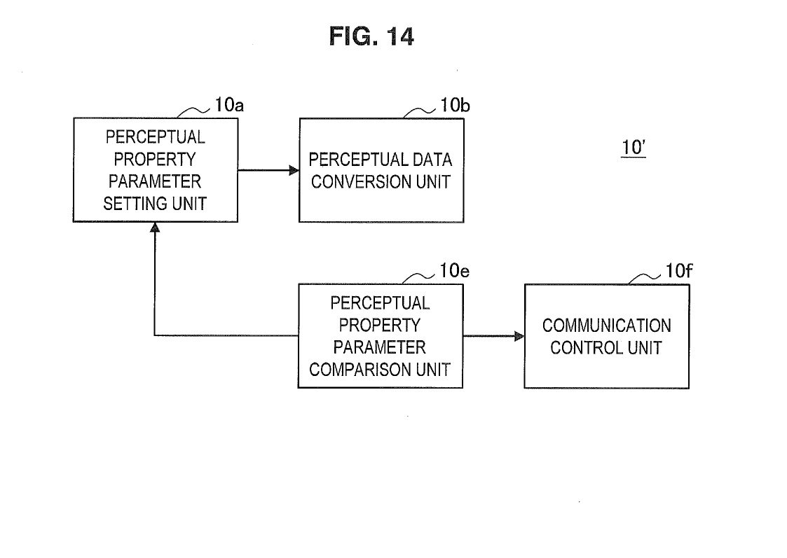

Next, with reference to FIG. 14, internal structures of the HMDs 1j and 1t according to the present embodiment will be described. The HMDs 1j and 1t according to the present embodiment have substantially the same structure of the HMD 1 illustrated in FIG. 2, but the main control unit 10 alone has a different structure. FIG. 14 is a diagram illustrating a functional structure of a main control unit 10′ of each of the HMDs 1j and 1t according to the second embodiment.

As illustrated in FIG. 14, the main control unit 10′ functions as a perceptual property parameter setting unit 10a, a perceptual data conversion unit 10b, a perceptual property parameter comparison unit 10e, and a communication control unit 10f.

The perceptual property parameter comparison unit 10e compares a perceptual property parameter received from a partner HMD with a perceptual property parameter of a wearer wearing the present HMD, and determines whether the perceptual property parameters match with each other. If the parameters do not match with each other, the perceptual property parameter comparison unit 10e outputs the comparison result (indicating that the perceptual property parameters do not match with each other) to the communication control unit 10f or the perceptual property parameter setting unit 10a.

When the communication control unit 10f receives, from the perceptual property parameter comparison unit 10e, the comparison result indicating the perceptual property parameters do not match with each other, the communication control unit 10f performs control such that the communication unit 21 transmits the perceptual property parameter of the wearer wearing the present HMD to the partner HMD. The communication control unit 10f may also perform control such that the perceptual data acquired by the present HMD is also transmitted to the partner HMD together with the perceptual property parameter of the wearer wearing the present HMD.

When the perceptual property parameter setting unit 10a receives, from the perceptual property parameter comparison unit 10e, the comparison result indicating that the perceptual property parameters do not match with each other, the perceptual property parameter setting unit 10a sets the perceptual property parameter received from the partner HMD. Alternatively, when the partner HMD has compared the perceptual property parameters, and when the perceptual property parameter is transmitted from the partner HMD because the perceptual property parameters have not matched with each other, the perceptual property parameter setting unit 10a may set the transmitted perceptual property parameter.

The perceptual data conversion unit 10b converts the perceptual data acquired by the present HMD or the perceptual data received from the partner HMD on the basis of the perceptual property parameter (perceptual property parameter received from the partner HMD in the present embodiment) that has been set by the perceptual property parameter setting unit 10a.

As above, the functional structure of the main control unit 10′ of each of the HMDs 1j and 1t according to the present embodiment has been described. Additionally, the perceptual property parameter setting unit 10a and the perceptual data conversion unit 10b can also perform substantially the same processing as performed by the structural elements according to the first embodiment.

(2-2-3. Operational Processing)

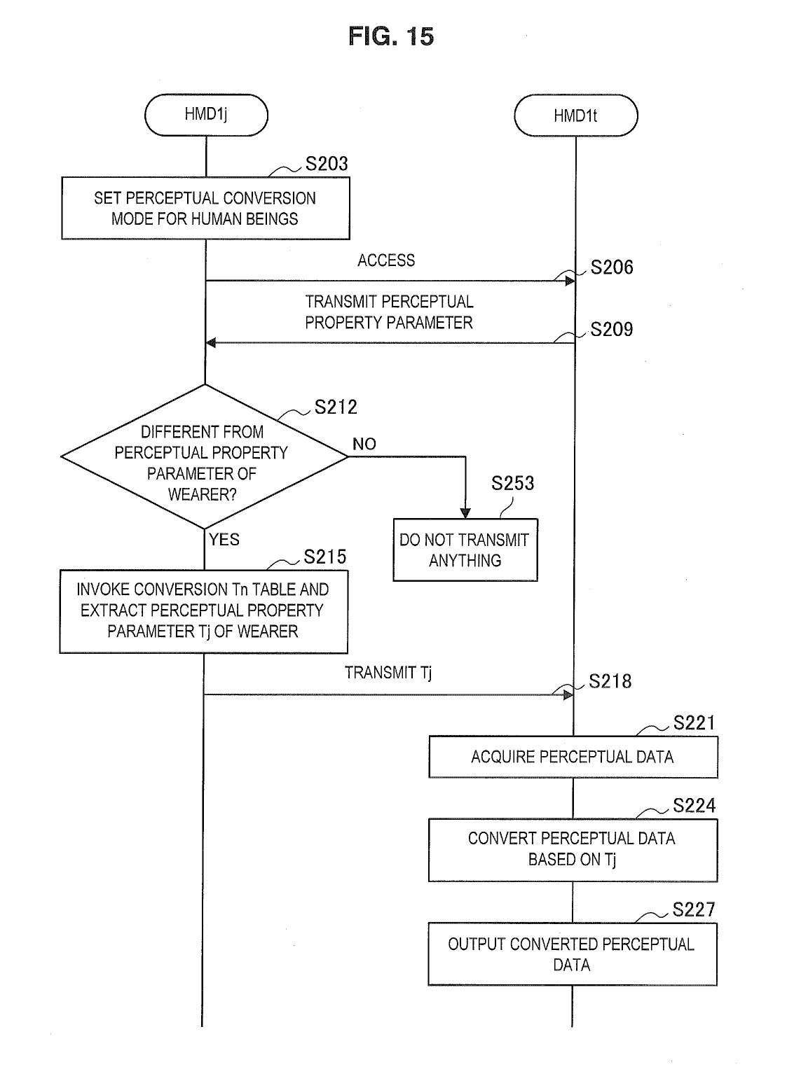

Next, with reference to FIGS. 15 to 18, conversion processing according to the present embodiment will be specifically described.

FIG. 15 is a flowchart illustrating perceptual conversion processing according to the second embodiment. As illustrated in FIG. 15, first of all, the HMD 1j is set, in step S203, to a perceptual conversion mode for human beings by the user 8j. The HMD 1j may also be set to a perceptual conversion mode, for example, through an operation of a switch (not shown) installed around the display unit 2 or the earphone speakers 5a of the HMD 1.

Subsequently, in step S206, the HMD 1j recognizes a living thing (such as the user 8t) present in the surrounding area, and accesses the HMD 1t of the user 8t. For example, the HMD 1j automatically recognizes the user 8t in the surrounding area in the illustrated example of FIG. 13, and accesses the HMD 1t for requesting a perceptual property parameter of the user 8t from the HMD 1t worn by the user 8t.

Next, in step S209, the HMD 1t transmits the perceptual property parameter of the user 8t to the HMD 1j in response to the request from the HMD 1j.

Subsequently, in step S212, the perceptual property parameter comparison unit 10e of the HMD 1j compares a perceptual property parameter according to the user 8j, who is a wearer wearing the HMD 1j, with the perceptual property parameter transmitted from the HMD 1t, and determines whether the perceptual property parameters are different from each other.

If the perceptual property parameters are not different (S212/No), the HMD 1j does not transmit, in step S213, the perceptual property parameter to the HMD 1t.

To the contrary, if the perceptual property parameters are different from each other (S212/Yes), the HMD 1j invokes, in step S215, a conversion Tn table and extracts a perceptual property parameter Tj of the user 8j wearing the HMD 1j.

Subsequently, in step S218, the communication control unit 10f of the HMD 1j performs control such that the perceptual property parameter Tj is transmitted to the HMD lt.

Next, in step S221, the HMD 1t acquires perceptual data from the area surrounding the user 8t.

Subsequently, in step S224, the HMD 1t has the perceptual property parameter setting unit 10a set the perceptual property parameter Tj, which has been received from the HMD 1j, and has the perceptual data conversion unit 10b convert the perceptual data, which has been acquired from the area surrounding the user 8t, on the basis of the perceptual property parameter Tj.

In step S227, the HMD 1t outputs the converted perceptual data.

The HMD 1j worn by the user 8j can hereby transmit the perceptual property parameter of the user 8j to the HMD 1t of the user 8t, and provide the user 8t with perceptual data that has been converted by the HMD 1t on the basis of the perceptual property parameter of the user 8j. Perceptual data acquired in the area surrounding the user 8t is converted and output on the basis of a perceptual property parameter of the user 8j, and the user 8t can experience how perceptual data is sensed by the sensory mechanisms of the user 8j.

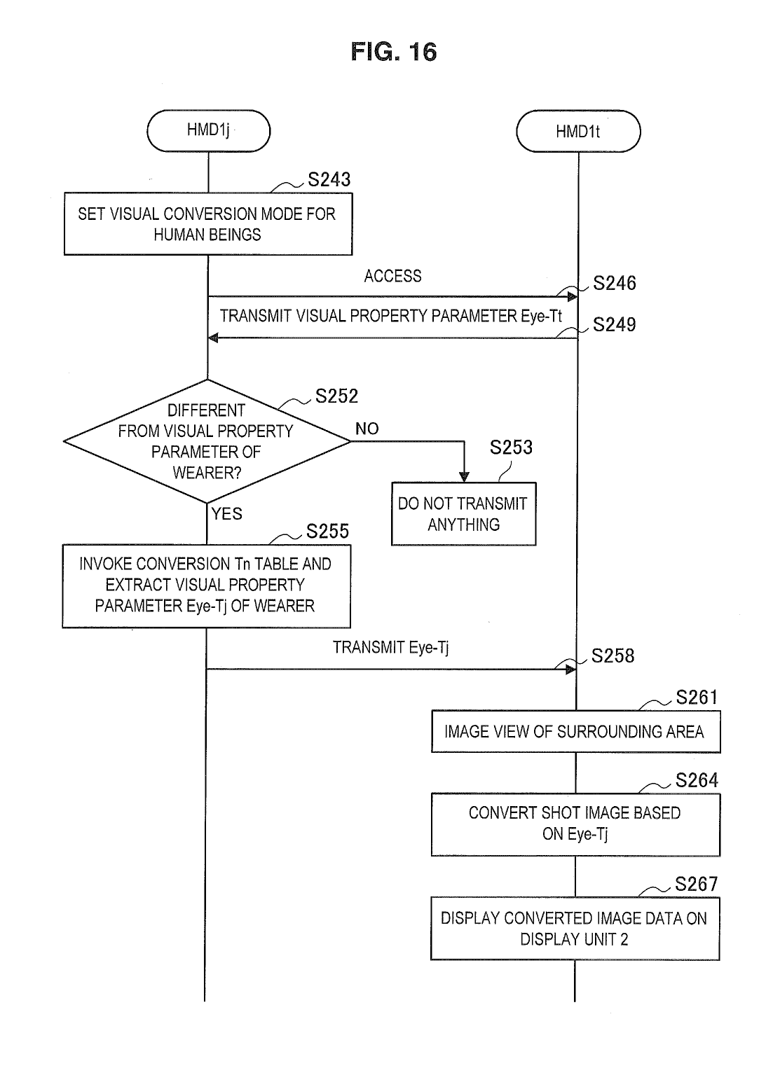

As above, the perceptual conversion processing of each of the HMD 1j and the HMD 1t according to the present embodiment has been described with reference to FIG. 15. The above-described perceptual conversion processing includes visual conversion processing, auditory conversion processing, and olfactory conversion processing. With reference to FIG. 16, it will be described below as a specific example of perceptual conversion processing that the HMD 1j and the HMD 1t each perform visual conversion processing.

FIG. 16 is a flowchart illustrating visual conversion processing according to the second embodiment. As illustrated in FIG. 16, first of all, the HMD 1j is set, in step S243, to a visual conversion mode for human beings by the user 8j. The HMD 1j may also be set to a visual conversion mode, for example, through an operation of a switch (not shown) installed around the display unit 2 of the HMD 1j.

Subsequently, in step S246, the HMD 1j accesses the HMD 1t present in the surrounding area. Specifically, the HMD 1j requests a visual property parameter of the user 8t wearing the HMD 1t from the HMD lt.

Next, in step S249, the HMD 1t transmits a visual property parameter Eye-Tt of the user 8t to the HMD 1j in response to the request from the HMD 1j.

Subsequently, in step S252, the perceptual property parameter comparison unit 10e of the HMD 1j compares a visual property parameter of the user 8j, who is a wearer wearing the HMD 1j, with the visual property parameter Eye-Tt transmitted from the HMD 1t, and determines whether the visual property parameters are different from each other.

If the visual property parameters are not different from each other (S252/No), the HMD 1j does not transmit, in step S253, anything to the HMD 1t.

To the contrary, if the visual property parameters are different from each other (S252/Yes), the HMD 1j invokes, in step S255, a conversion Tn table, and extracts a visual property parameter Eye-Tj of the wearer 8j.

Subsequently, in step S258, the communication control unit 10f of the HMD 1j performs control such that the visual property parameter Eye-Tj is transmitted to the HMD 1t.

Next, in step S261, the HMD 1t images a view of the surrounding area with the imaging unit 3 of the HMD 1t, and acquires the shot image.

Subsequently, in step S264, the HMD 1t has the perceptual property parameter setting unit 10a set the visual property parameter Eye-Tj received from the HMD 1j, and has the perceptual data conversion unit 10b convert the shot image acquired in S261 on the basis of the visual property parameter Eye-Tj.

In step S267, the HMD 1t displays the conversion image data on the display unit 2 of the HMD lt.

The HMD 1t worn by the user 8j can hereby transmit the visual property parameter of the user 8j to the HMD 1t of the user 8t, and show the user 8t the image data that has been converted by the HMD 1t on the basis of the visual property parameter of the user 8j. A view of the area surrounding the user 8t is converted and displayed on the basis of a visual property parameter of the user 8j, and the user 8t can experience how the view of the surrounding area looks to the eyes of the user 8j.

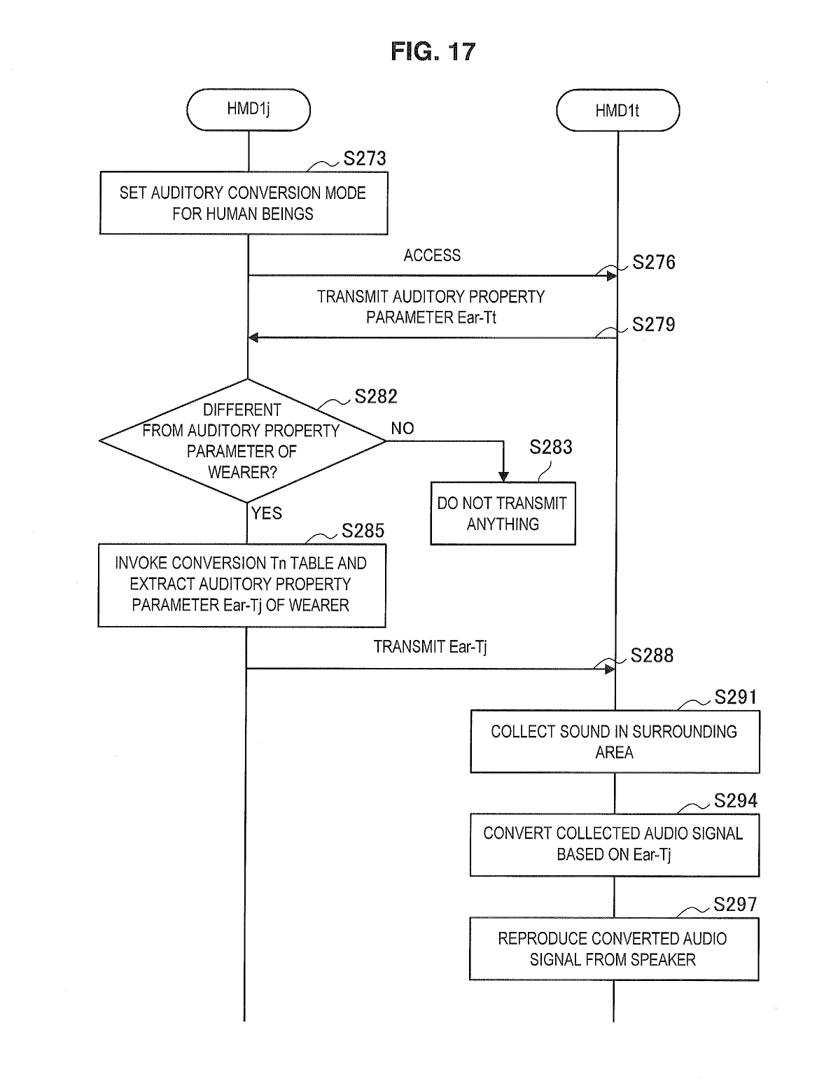

As above, it has been specifically described that the HMD 1j and the HMD 1t each perform visual conversion processing. Next, with reference to FIG. 17, it will be described that the HMD 1j and the HMD 1t each perform auditory conversion processing.

FIG. 17 is a flowchart illustrating auditory conversion processing according to the second embodiment. As illustrated in FIG. 17, first of all, the HMD 1j is set, in step S273, to an auditory conversion mode for human beings by the user 8j. The HMD 1j may also be set to an auditory conversion mode, for example, through an operation of a switch (not shown) installed around the earphone speakers 5a of the HMD 1j.

Subsequently, in step S276, the HMD 1j accesses the HMD 1t present in the surrounding area. Specifically, the HMD 1j requests an auditory property parameter of the user 8t wearing the HMD 1t from the HMD 1t.

Next, in step S279, the HMD 1t transmits an auditory property parameter Ear-Tt of the user 8t to the HMD 1j in response to the request from the HMD 1j.

Subsequently, in step S282, the perceptual property parameter comparison unit 10e of the HMD 1j compares an auditory property parameter of the user 8j, who is a wearer wearing the HMD 1j, with the auditory property parameter Ear-Tt transmitted from the HMD 1t, and determines whether the auditory property parameters are different from each other.

If the auditory property parameters are not different from each other (S282/No), the HMD 1j does not transmit, in step S283, anything to the HMD 1t.

To the contrary, if the perceptual property parameters are different from each other (S282/Yes), the HMD 1j invokes, in step S285, a conversion Tn table, and extracts an auditory property parameter Ear-Tj of the wearer 8j.

Subsequently, in step S288, the communication control unit 10f of the HMD 1j performs control such that the auditory property parameter Ear-Tj is transmitted to the HMD 1t.

Next, in step S291, the HMD 1t collects a sound in the surrounding area with the audio input unit 6 of the HMD 1t, and acquires the audio signal data (audio signal).

Subsequently, in step S294, the HMD 1t has the perceptual property parameter setting unit 10a set the auditory property parameter Ear-Tj received from the HMD 1j, and has the perceptual data conversion unit 10b convert the audio signal acquired in S291 on the basis of the auditory property parameter Ear-Tj.

In step S297, the HMD 1t reproduces the converted audio signal from the audio output unit 5 (speaker) of the HMD 1t.

The HMD 1j worn by the user 8j can hereby transmit the auditory property parameter of the user 8j to the HMD 1t of the user 8t, and allows the user 8t to hear the audio signal converted by the HMD 1t on the basis of the auditory property parameter of the user 8j. A sound in the area surrounding the user 8t is converted and reproduced on the basis of the auditory property parameter of the user 8j so that the user 8t can experience how the sound in the surrounding area sounds to the ears of the user 8j.

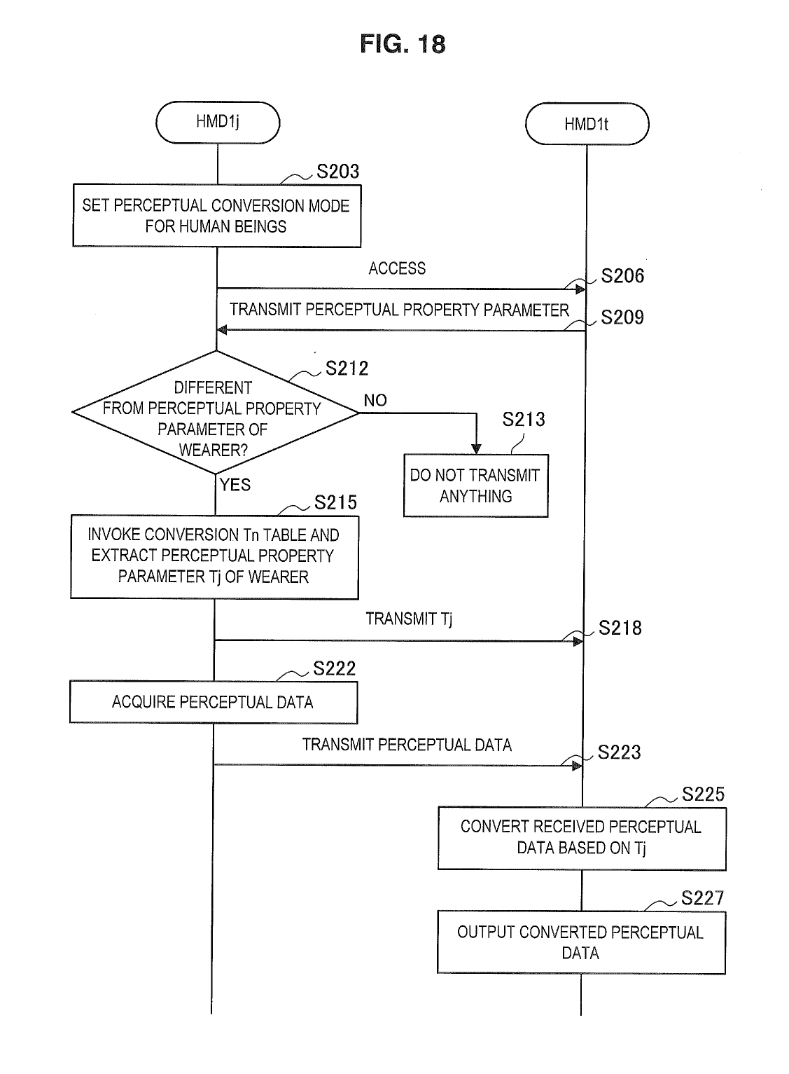

As above, it has been described with reference to FIGS. 15 to 17 that the HMD 1j transmits a perceptual property parameter of the user 8j to the HMD 1t worn by the user 8t. The perceptual conversion processing performed by the HMD 1j and the HMD 1t according to the present embodiment is not limited to the examples illustrated in FIGS. 15 to 17. For example, perceptual data acquired by the HMD 1j may be transmitted together to the HMD 1t. Next, with reference to FIG. 18, the detailed description will be made.

FIG. 18 is a flowchart illustrating other perceptual conversion processing according to the second embodiment. The processing shown in steps S203 to S218 in FIG. 18 is substantially the same as the processing in the steps illustrated in FIG. 15 so that the description will be herein omitted.

Subsequently, in step S222, the HMD 1j acquires perceptual data from the area surrounding the user 8j. Specifically, the HMD 1j, for example, acquires a shot image obtained by the imaging unit 3 of the HMD 1j imaging a view of the area surrounding the user 8j, or acquires an audio signal obtained by the audio input unit 6 of the HMD 1j collecting a sound in the area surrounding the user 8j.

Next, in step S223, the communication control unit 10f of the HMD 1j performs control such that the perceptual data acquired from the area surrounding the user 8t is transmitted to the HMD 1t.

Subsequently, in step S225, the HMD 1t has the perceptual property parameter setting unit 10a set the perceptual property parameter Tj received from the HMD 1j, and has the perceptual data conversion unit 10b convert the perceptual data transmitted from the HMD 1j on the basis of the perceptual property parameter Tj.

In step S227, the HMD 1t outputs the converted perceptual data.

The HMD 1j worn by the user 8j can hereby transmit the perceptual property parameter and the perceptual data of the user 8j to the HMD 1t, and provide the user 8t with the perceptual data that has been converted by the HMD 1t on the basis of the perceptual property parameter of the user 8j. Perceptual data acquired in the area surrounding the user 8j is converted and output on the basis of a perceptual property parameter of the user 8j, and the user 8t can experience how the user 8j senses the surrounding area with the sensory mechanisms of the user 8j.

Specifically, for example, the user 8t can see a view currently seen by the user 8j as if the user 8t saw the view with the eyes of the user 8j.

As above, it has been described that the HMD 1j transmits a perceptual property parameter and perceptual data to the HMD 1t. When a perceptual property parameter received from the HMD 1t is different from a perceptual property parameter of the user 8j, the HMD 1j may set the perceptual property parameter received from the HMD 1t, convert the perceptual data acquired by the HMD 1j on the basis thereof, and provide the user 8j with the converted perceptual data. Furthermore, when a perceptual property parameter received from the HMD 1t is different from a perceptual property parameter of the user 8j, the HMD 1j may set the perceptual property parameter received from the HMD 1t, convert the perceptual data received from the HMD 1t on the basis thereof, and provide the user 8j with the converted perceptual data.

### 3. CONCLUSION

As described above, the HMD 1 according to the present embodiment can convert, in real time, perceptual data currently sensed by the user 8 to perceptual data sensed by another living thing with a structurally different sensory mechanism, on the basis of a perceptual property parameter according to a desired living-thing. The user 8 can hereby experience a view and a sound in the surrounding area as a view and a sound that are sensed by the eyes and the ears of another living thing.

The perceptual property parameter setting unit 10a of the HMD 1 according to the present embodiment sets a perceptual property parameter according to a living thing selected by the user 8 or a living thing that is automatically recognized as being present in the surrounding area.

Moreover, the perceptual property parameter setting unit 10a of the HMD 1 according to the present embodiment may set a perceptual property parameter according to not only living things other than human beings, but also to human beings belonging to different races and sex from the race and sex of the user 8.

When there are multiple HMDs 1 according to the present embodiment, the multiple HMDs 1 can transmit and receive perceptual property parameters and perceptual data of the wearers to and from each other.

It should be understood by those skilled in the art that various modifications, combinations, sub-combinations and alterations may occur depending on design requirements and other factors insofar as they are within the scope of the appended claims or the equivalents thereof.

For example, it is also possible to produce a computer program for causing hardware such as a CPU, ROM, and RAM built in the HMD 1 to execute the above-described functions of the HMD 1. There is also provided a computer-readable storage medium having the computer program stored therein.

Additionally, the present technology may also be configured as below:

(1) A signal processing apparatus including:

a setting unit configured to set a perceptual property parameter for changing perceptual data to desired perceptual data; and

a conversion unit configured to convert currently acquired perceptual data to the desired perceptual data in real time in accordance with the perceptual property parameter that has been set by the setting unit.

(2) The signal processing apparatus according to (1), further including:

a generation unit configured to generate a selection screen for selecting the desired perceptual data.

(3) The signal processing apparatus according to (1) or (2),

wherein the perceptual property parameter is different in accordance with a type of a living thing.

(4) The signal processing apparatus according to any one of (1) to (3), further including:

a recognition unit configured to automatically recognize a living thing present in a surrounding area,

wherein the setting unit sets a perceptual property parameter for changing the perceptual data to perceptual data according to the living thing recognized by the recognition unit.

(5) The signal processing apparatus according to (4),

wherein the perceptual property parameter according to the living thing recognized by the recognition unit is acquired from an external space.

(6) The signal processing apparatus according to any one of (1) to (5), further including:

an acquisition unit configured to acquire perceptual data in an area surrounding a user,

wherein the conversion unit converts the perceptual data acquired by the acquisition unit, based on the perceptual property parameter.

(7) The signal processing apparatus according to (4), further including:

a reception unit configured to receive perceptual data in an area surrounding the living thing recognized by the recognition unit,

wherein the conversion unit converts the perceptual data received by the reception unit, based on the perceptual property parameter.

(8) The signal processing apparatus according to (4), further including:

a transmission unit configured to transmit, when a perceptual property parameter according to the living thing recognized by the recognition unit is different from a perceptual property parameter of a user, the perceptual property parameter of the user to a device held by the living thing.

(9) The signal processing apparatus according to (8), further including:

an acquisition unit configured to acquire perceptual data in an area surrounding the user,

wherein the transmission unit transmits the perceptual data in the area surrounding the user together, the perceptual data being acquired by the acquisition unit.

(10) The signal processing apparatus according to any one of (1) to (9), further including:

a reproduction unit configured to reproduce the desired perceptual data converted by the conversion unit.

(11) The signal processing apparatus according to any one of (1) to (10),

wherein the perceptual data is image data, audio data, pressure data, temperature data, humidity data, taste data, or smell data.

(12) The signal processing apparatus according to any one of (1) to (11),

wherein the perceptual property parameter is a visual property parameter, an auditory property parameter, a tactile property parameter, a gustatory property parameter, or an olfactory property parameter.

(13) A non-transitory computer-readable storage medium having a program stored therein, the program causing a computer to function as:

a setting unit configured to set a perceptual property parameter for changing perceptual data to desired perceptual data; and

a conversion unit configured to convert currently acquired perceptual data to the desired perceptual data in real time in accordance with the perceptual property parameter that has been set by the setting unit.

What is claimed is:

1. A signal processing apparatus comprising:
a setting unit configured to set a perceptual property parameter for changing perceptual data to desired perceptual data; and
a conversion unit configured to convert currently acquired perceptual data to the desired perceptual data in real time in accordance with the perceptual property parameter that has been set by the setting unit.

2. The signal processing apparatus according to claim 1, further comprising:
a generation unit configured to generate a selection screen for selecting the desired perceptual data.

3. The signal processing apparatus according to claim 1,
wherein the perceptual property parameter is different in accordance with a type of a living thing.

4. The signal processing apparatus according to claim 1, further comprising:
a recognition unit configured to automatically recognize a living thing present in a surrounding area,
wherein the setting unit sets a perceptual property parameter for changing the perceptual data to perceptual data according to the living thing recognized by the recognition unit.

5. The signal processing apparatus according to claim 4,
wherein the perceptual property parameter according to the living thing recognized by the recognition unit is acquired from an external space.

6. The signal processing apparatus according to claim 1, further comprising:
an acquisition unit configured to acquire perceptual data in an area surrounding a user,
wherein the conversion unit converts the perceptual data acquired by the acquisition unit, based on the perceptual property parameter.

7. The signal processing apparatus according to claim 4, further comprising:
a reception unit configured to receive perceptual data in an area surrounding the living thing recognized by the recognition unit,
wherein the conversion unit converts the perceptual data received by the reception unit, based on the perceptual property parameter.

8. The signal processing apparatus according to claim 4, further comprising:
a transmission unit configured to transmit, when a perceptual property parameter according to the living thing recognized by the recognition unit is different from a perceptual property parameter of a user, the perceptual property parameter of the user to a device held by the living thing.

9. The signal processing apparatus according to claim 8, further comprising:
an acquisition unit configured to acquire perceptual data in an area surrounding the user,
wherein the transmission unit transmits the perceptual data in the area surrounding the user together, the perceptual data being acquired by the acquisition unit.

10. The signal processing apparatus according to claim 1, further comprising:
a reproduction unit configured to reproduce the desired perceptual data converted by the conversion unit.

11. The signal processing apparatus according to claim 1,
wherein the perceptual data is image data, audio data, pressure data, temperature data, humidity data, taste data, or smell data.

12. The signal processing apparatus according to claim 1,
wherein the perceptual property parameter is a visual property parameter, an auditory property parameter, a tactile property parameter, a gustatory property parameter, or an olfactory property parameter.

13. A non-transitory computer-readable storage medium having a program stored therein, the program causing a computer to function as:
a setting unit configured to set a perceptual property parameter for changing perceptual data to desired perceptual data; and
a conversion unit configured to convert currently acquired perceptual data to the desired perceptual data in real time in accordance with the perceptual property parameter that has been set by the setting unit.
